(19) United States
(12) Patent Application Publication
(10) Pub. No.: US 2016/0098167 A1
(43) Pub. Date: Apr. 7, 2016

(54) Remote Touch-Based Control for Distributed Antenna System Interface

(71) Applicant: Westell Technologies, Inc., Aurora, IL (US)

(72) Inventor: Anal R. Shah, Aurora, IL (US)

(21) Appl. No.: 14/874,002

(22) Filed: Oct. 2, 2015

Related U.S. Application Data
(60) Provisional application No. 62/060,470, filed on Oct. 6, 2014.

(51) Int. Cl. G06F 3/0488; G06F 3/0484; G06F 3/0481

(52) U.S. Cl. CPC G06F 3/0488; G06F 3/04817; G06F 3/04842; G06F 2203/04801

(57) ABSTRACT

Devices, systems, and methods for controlling a distributed antenna system interface (DAS-I) device are described. An example method may provide for control and/or monitoring of a DAS-I system via a GUI that includes a plurality of point-of-interface (POI) slot icons, with each POI slot icon corresponding to at least one of a plurality of POI modules of the DAS-interface device. A POI slot icon may be selected via the GUI in order to bring up graphical control and/or monitoring features for the corresponding POI module. A user may then interact with these features to control and/or monitor the POI module.

### CROSS-REFERENCE TO RELATED APPLICATIONS

This application claims priority to U.S. Provisional Patent Application No. 62/060,470, filed on Oct. 6, 2014, which is incorporated herein by reference in its entirety and for all purposes.

### BACKGROUND

Distributed antenna systems (DASs) may be used to extend the network coverage of, e.g., cellular networks. For example, a DAS may be implemented in a stadium or office building to extend the coverage of cellular networks into such areas, where service from cellular networks' base transceiver stations may be poor.

Distributed antenna system interface (DAS-I) systems may be implemented to provide a controllable interface between cellular networks and a DAS. A DAS-I system may be implemented in a standalone device that is installed at or near the DAS that it controls (e.g., in a stadium or office building where a DAS is installed). The DAS-I system may allow a network engineer and/or cellular service providers control the distribution of the resources provided by the DAS. However, control of existing DAS-I devices may require an on-site engineer.

Unless otherwise indicated herein, the materials described in this section are not prior art to the claims in this application and are not admitted to be prior art by inclusion in this section.

### SUMMARY

Example embodiments may improve the functionality of DAS-I systems by providing remote access and control of a DAS-I system via a touch-based interface. For example, example embodiments may provide a touch-based graphical user interface (GUI), which allows for remote control of a DAS-I system via a mobile phone or tablet computer, among other possibilities.

In one aspect, an example apparatus includes a touchscreen, a non-transitory computer readable medium, and program instructions stored on the non-transitory computer readable medium. The program instructions are executable by at least one processor to: (a) display, on the touchscreen, a touch-based graphical user-interface (GUI) for controlling at least one distributed antenna system (DAS) interface device, wherein the GUI comprises a plurality of point-of-interface (POI) slot icons, wherein each POI slot icon corresponds to at least one of a plurality of POI modules of the DAS-interface device; (b) receive, via the touchscreen, touch input data indicating to select a particular POI slot icon from the plurality of POI slot icons; and (c) display, on the touchscreen, a control panel comprising touch-based controls for the POI module corresponding to the selected POI slot icon.

In another aspect, an example apparatus includes an interface to a graphic display device, an interface to at least one input device, a non-transitory computer readable medium, and program instructions stored on the non-transitory computer readable medium. The program instructions are executable by at least one processor to: (a) display, on the graphic display device, a graphical user-interface (GUI) for controlling at least one distributed antenna system (DAS) interface device, wherein the GUI comprises a plurality of point-of-interface (POI) slot icons, wherein each POI slot icon corresponds to at least one of a plurality of POI modules of the DAS-interface device; (b) receive, via the at least one input device, first input data indicating to select a particular POI slot icon from the plurality of POI slot icons; and (c) display, on the graphic display device, a control panel comprising touch-based controls for the POI module corresponding to the selected POI slot icon.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 is a block diagram illustrating a portion of a network, according to an example embodiment.

FIG. 2 illustrates a login screen, according to an example embodiment.

FIG. 3 shows a screen from an example GUI, which may be shown once a user logs in.

FIGS. 4A, 4B, 4C, and 4D show GUI screens that include uplink information and features, according to an example embodiment.

FIGS. 4E and 4F illustrate a screen and a parameter adjustment window from a GUI, according to an example embodiment.

FIGS. 5A, 5B, 5C, and 5D show GUI screens that include downlink information and features, according to an example embodiment.

FIG. 6A shows a GUI screen where alarms associated with a DAS-I system are listed, according to an example embodiment.

FIG. 6B shows a GUI screen in which a user has opened an alarm filter settings window, according to an example embodiment.

FIG. 6C shows a GUI screen where settings of the application can be adjusted via a touchscreen interface, according to an example embodiment.

FIG. 6D shows a GUI screen GUI with a fan settings drop-down, according to an example embodiment.

FIG. 6E shows a GUI screen with a DAS-I selection drop-down feature, according to an example embodiment.

FIGS. 7A to 7I show GUI screens from an example application, which may be implemented on a smaller touch-based interface, such as on the touchscreen of a mobile phone, according to example embodiments.

FIG. 8 is a flow chart illustrating a method, according to an example embodiment.

FIG. 9 is a block diagram illustrating a computing device, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

### I. ILLUSTRATIVE NETWORKS AND DAS-INTERFACE DEVICES

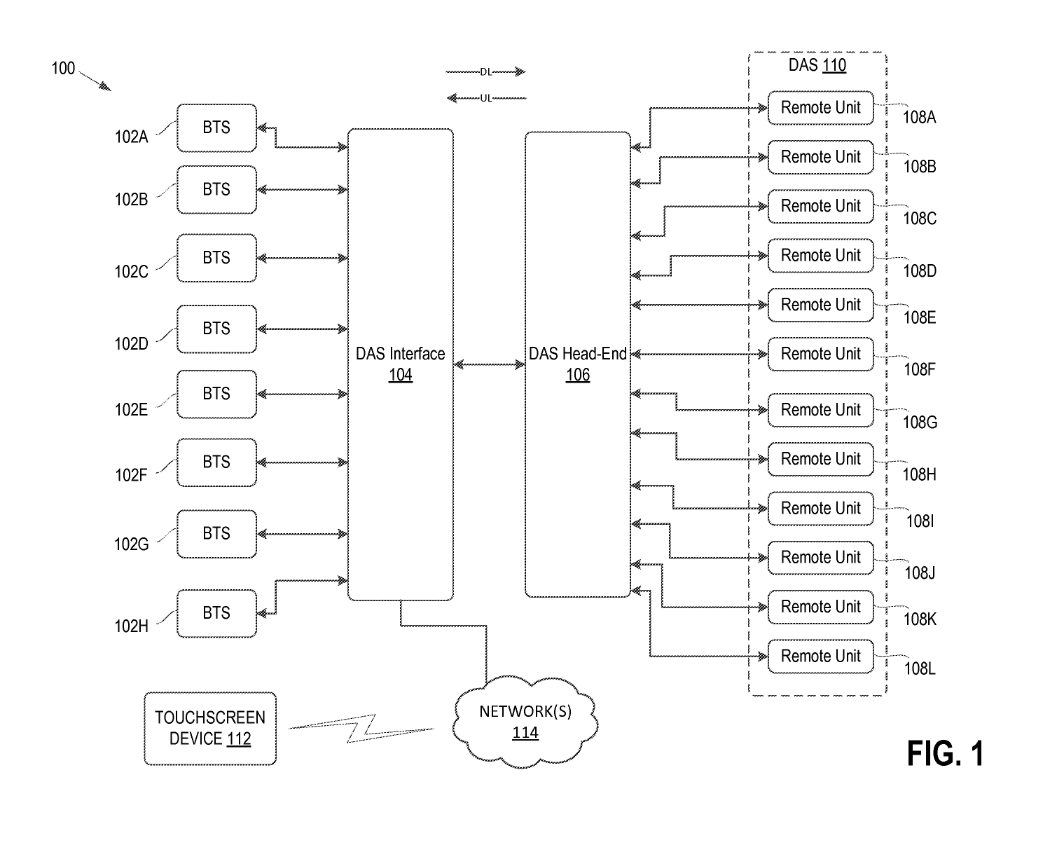

FIG. 1 is a block diagram illustrating a portion of a network 100, according to an example embodiment. The network 100 includes a number of base transceiver stations (BTSs) 102A to 102H from one or more cellular networks, a distributed antenna system interface (DAS-I) system 104, a distributed antenna system (DAS) 110, and a DAS head end 106. The DAS 110 includes a number of remote units 108_A to 108_B (e.g., antenna systems). Further, DAS-I system 104 may be network connected, and as such, may communicate with a touchscreen device 112 via at least one network 114. In an example configuration, the DAS-I system 104 may provide Radio Frequency (RF) conditioning between BTSs, such as BTSs 102A to 102H, and a DAS, such as DAS 110.

In practice, DAS-I system 104 may be implemented with a currently available commercial product, such as the ClearLink™ Universal DAS Interface Tray (UDIT™) sold by Westell Inc. Such a UDIT may help to simplify connectivity, and may occupy less space as compared to passive equivalent solutions, while at the same time providing high power BTS conditioning, Low Passive Intermodulation (PIM), active noise detection, signal splitting/combining, active and remote power management, dynamic power control, alarming, and real-time monitoring. Of course, DAS-I system 104 may take other forms, without departing from the scope of the invention.

DAS-I system 104 may be configured to connect only to BTSs from a single Wireless Service Provider (WSP), or may be configured to function as a neutral host, which can simultaneously connect to BTSs from a number of different WSPs and/or operator systems. In the latter case, signals from multiple WSPs, which perhaps use different technologies, can be balanced to more effectively and dynamically allocate and re-distribute power between BTSs of different WSPs.

DAS head-end 106 may be configured to receive the output from the DAS-I system 104, and redistribute the power from the output to the remote units 108_A to 108_B. In particular, the DAS head-end 106 may receive RF input power that is output from the DAS-I system, and convert it to optical input power which can then be sent to remote units 108_A to 108_B via fiber optic cables. In an example embodiment, DAS-I system 104 may be co-located with a DAS head-end 106. Further, note that while DAS-I system 104 and DAS head-end 106 are illustrated as separate components in FIG. 1, other embodiments may include a single device that provides the functionality of both a DAS-I system and a DAS head-end. In such an embodiment, the combined DAS-I and DAS head-end may connect to both base stations and the remote units making up a DAS.

Each DAS-I system 104 may include a number of point of interface (POI) modules (also referred to herein as POI “slots”). For instance, in an example embodiment, DAS-I system 104 may include twelve POI modules. However, it is possible that example embodiments may be implemented in conjunction with DAS-I systems with more or less than twelve POI modules.

Each POI module in DAS-I system 104 may include hardware that is operable to establish uplink (UL) and downlink (UL) connections with a BTS. For example, a given POI module in DAS-I system 104 may include an RF Duplexer and Up and Down stream conditioning paths for UL and DL signals. Thus, if a given BTS 102A is assigned to a given POI module, then the POI module can: (a) receive UL signals from one or more of the remote units 108A to 108L, and relay these received UL signals to the BTS 102A, and (b) receive DL signals from the BTS 102A, and relay the DL signals from BTS 102A to one or more of the remote units 108A to 108L. Further, note that each POI module may include multiple processors, with at least a first processor dedicated to the uplink path and a second processor dedicated to the downlink path.

In a further aspect, a given POI module of DAS-I system 104 may be configured to condition UL signals and DL signals. For instance, in an example configuration, a given POI module may be configured to apply gain and/or attenuate the UL signal, and to attenuate the DL signal. Further, according to an example embodiment, such signal conditioning may be monitored and/or controlled remotely, via an application running on touchscreen device 112.

In some embodiments, the DAS-I system may provide various downlink power management features, which may be adjusted and controlled, at least to some extent, by the user. To provide some examples, for the downlink of a given POI module, the DAS-I system 104 may monitor composite downlink RF power at the output of the DAS-I system to help keep the composite downlink RF power below a defined value (which may be set by the user either locally or remotely via touchscreen device 112). As another example of a downlink power management feature, DAS-I system 104 may monitor and control power incident on the DAS equipment, such that it does not exceed the ratings for the equipment. Further, the DAS-I system 104 may be configured to allow remote monitoring allows the user to remotely monitor the status of the DAS service plus remotely make any necessary power level changes.

As another example of a downlink power management feature, DAS-I system 104 may set and/or allow for user adjustment of a maximum input power for the downlink input on each POI module. As a specific example, a DAS-I system 104 may only allow the input power to be 100 W (+50 dBm) at each POI module. Other specific examples are also possible.

As another example of a downlink power management feature, DAS-I system 104 may measure and report downlink input levels at each POI module (e.g., from the BTS connected to each POI module). Additionally or alternatively, DAS-I system 104 may measure and report downlink output levels (e.g., to DAS head-end 106). Such measurements and/or reports may be made continuously, periodically, or on an as-needed basis.

As yet another example of a downlink power management feature, DAS-I system 104 may allow for alarm threshold levels to be set, either locally or remotely, based on minimum and/or maximum downlink power levels at the downlink input and/or downlink output for each POI module. Once such an alarm is set, the DAS-I system 104 may monitor power levels, and generate an alarm notification when a threshold level is exceeded. Other types of alarms are also possible.

According to an example embodiment, alarm notifications that are generated by the DAS-I system 104 can be remotely monitored through a Simple Network Management Protocol (SNMP) or Graphical User Interface (GUI). As such, DAS-I system 104 may send the alarms to a touchscreen device 112 and/or to other devices via one or more networks 114. Note that the alarm notifications may be sent directly to such devices, or may be sent to a central server system, which aggregate alarm notifications from multiple DAS-I systems and coordinate the distribution of alarm notifications to the appropriate user devices.

As a further example of a downlink power management feature, DAS-I system 104 may allow for a “clamp down” level to be set by the user. When the downlink input power rises such that the downlink output power level is expected to exceed the clamp down level, the DAS-I system 104 will “clamp down” on the output power by, e.g., making adjustments to keep the downlink output power at or below some threshold level.

As a further example of a downlink power management feature, DAS-I system 104 may provide or support a user interface that allows the downlink attenuation to be adjusted by the user, either locally or remotely. As one specific example, a GUI on touchscreen device 112 may allow the user to adjust the downlink attenuation of a given POI module from 0 dB up to 31 dB.

In some embodiments, the DAS-I system may provide various uplink power management features, which may be adjusted and controlled, at least to some extent, by the user. As an example, for the downlink of a given POI module, the DAS-I system 104 may provide or support a user interface that allows the uplink attenuation to be adjusted by the user, either locally or remotely. For instance, in one implementation, a GUI on touchscreen device 112 may allow the user to adjust the downlink attenuation of a given POI module from 0 dB up to 35 dB. Other implementations are also possible.

Further, the DAS-I system 104 may provide or support a user interface that allows the uplink gain of a given POI module to be adjusted by the user, either locally or remotely. For instance, in one implementation, a GUI on touchscreen device 112 may allow the user to adjust the uplink gain of a given POI module from 0 dB up to 25 dB. Other implementations are also possible.

As another example of an uplink power management feature, the DAS-I system 104 may allow the user to specify, for each POI module, fifteen frequency points with an uplink band of interest, where power will be measured by the DAS-I system.

As yet another example of an uplink power management feature, for each POI slot, the DAS-I system 104 may allow the user to select and configure up to three Sub-Bands, and up to five slices per Sub-Band (for fifteen slices in total). DAS-I system 104 may then measure and report power for each slice. In an example embodiment, each slice may be 200 kHz in bandwidth, and the slices can be contiguous or spread out (e.g., non-contiguous). Further, the DAS-I system may allow a user to set and adjust a maximum Threshold Noise Input Power per slice, and issue an alarm notification if any such threshold is exceeded. Other embodiments are possible.

Further, according to an example embodiment, power management features, such as those described above, may be accessed and/or controlled remotely, via an application running on touchscreen device 112. The touchscreen device 112 may be a smartphone or tablet computer, for example. Of course, other types of touchscreen devices are possible.

In a further aspect, one of the slots in a DAS-I 104 may include a combiner module instead of a standard POI module. For instance, a ClearLink™ UDIT™ may include one, or possibly more than one, 4-way Combiner Module with Spectrum Analysis Capabilities, which is also sold by Westell Inc. Other examples of combiners are also possible.

In an example embodiment, DAS-I 104 may include a combiner module that is operable to divide or sum signals going between a given BTS and a DAS. The combiner may help the DAS-I system resolve or improve upon spectral density issues by allowing disparate frequency bands to be grouped together and passed to the DAS. A power meter in the Downlink path of the Combiner module monitors the presence of the downlink signal(s) in real time. Further, in some embodiments, spectrum analysis may be provided in the uplink path of the combiner module. Spectrum analysis may be useful for offsite technicians and operators in Network Operation Centers (NOCs), as it may help identify and isolate sources of interference in the uplink path without the need to dispatch personnel to location where the DAS system is installed. Accordingly, in an example embodiment, an application on touchscreen device 112 may provide a touch-based GUI via which a user can view information related to the uplink input power level for a combiner module. Further, the application may allow the user to remotely specify the uplink frequencies for which power information is display, and to may allow the user to view the specified frequencies in a graph or table.

### II. ILLUSTRATIVE TOUCH-BASED APPLICATIONS

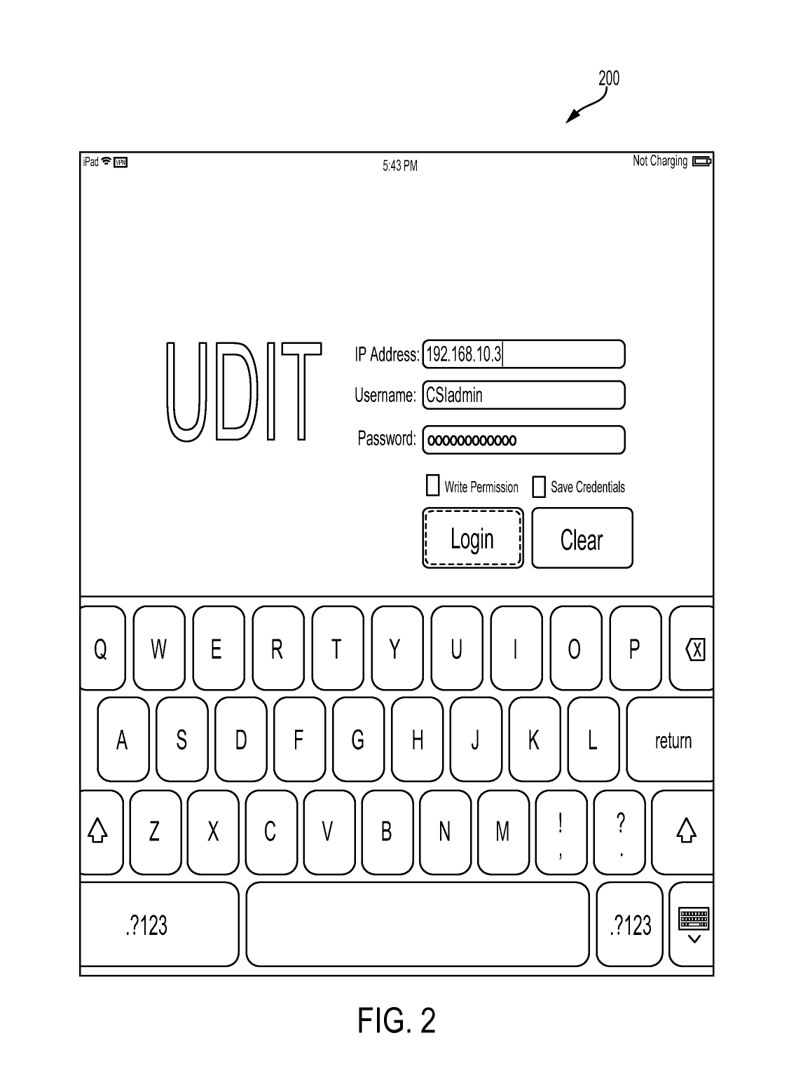

FIGS. 2 to 7I illustrate screens from touch-based graphical user interface (GUIs), according to an example embodiment. Such GUIs may be displayed on a touchscreen interface, such as those that are commonly provided on mobile devices such as smartphones and tablet computers, among other possibilities.

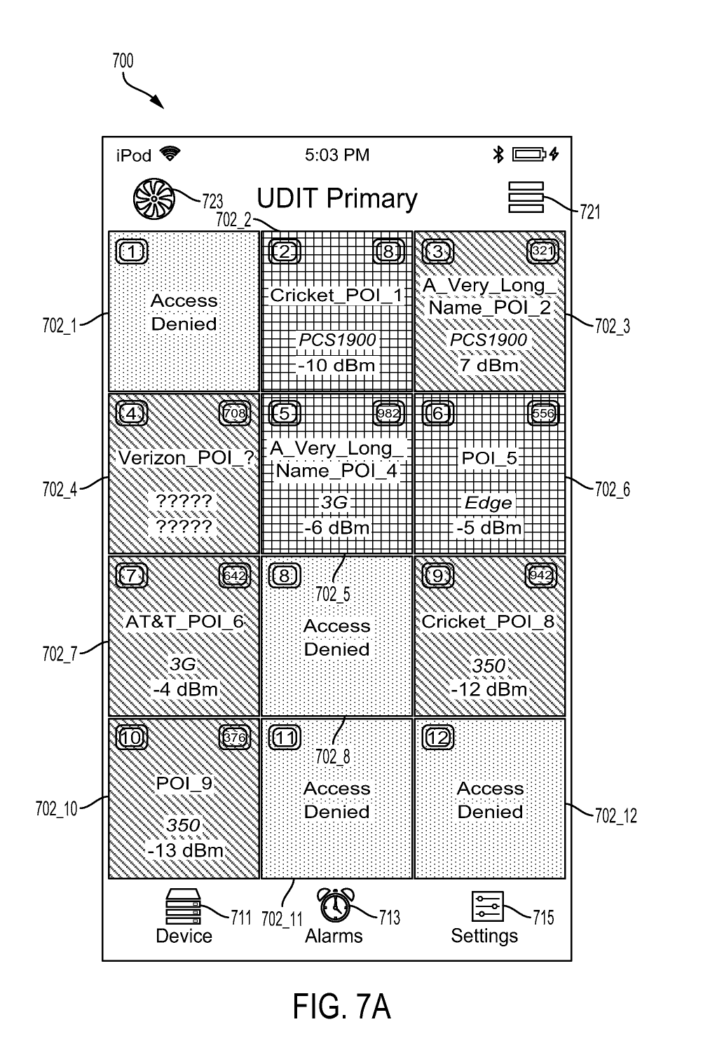

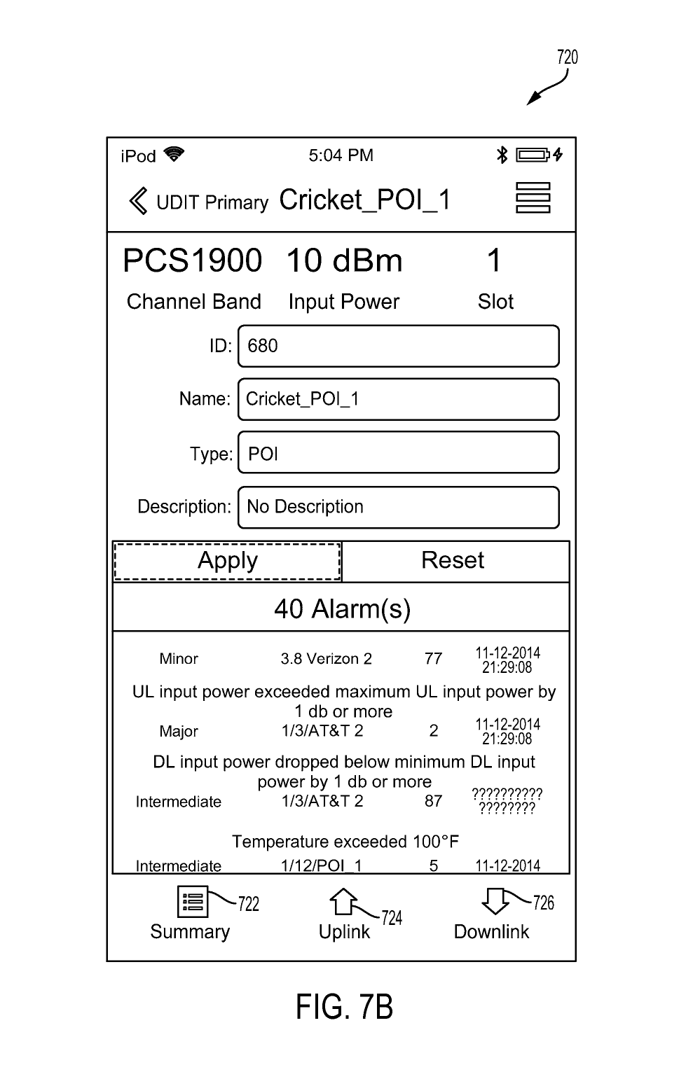

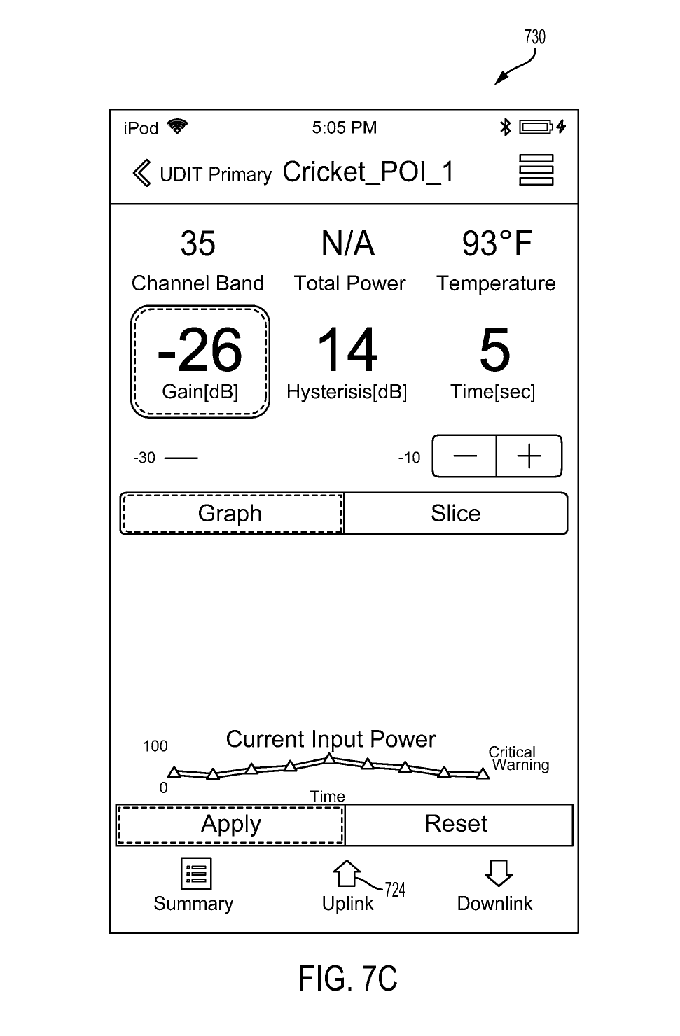

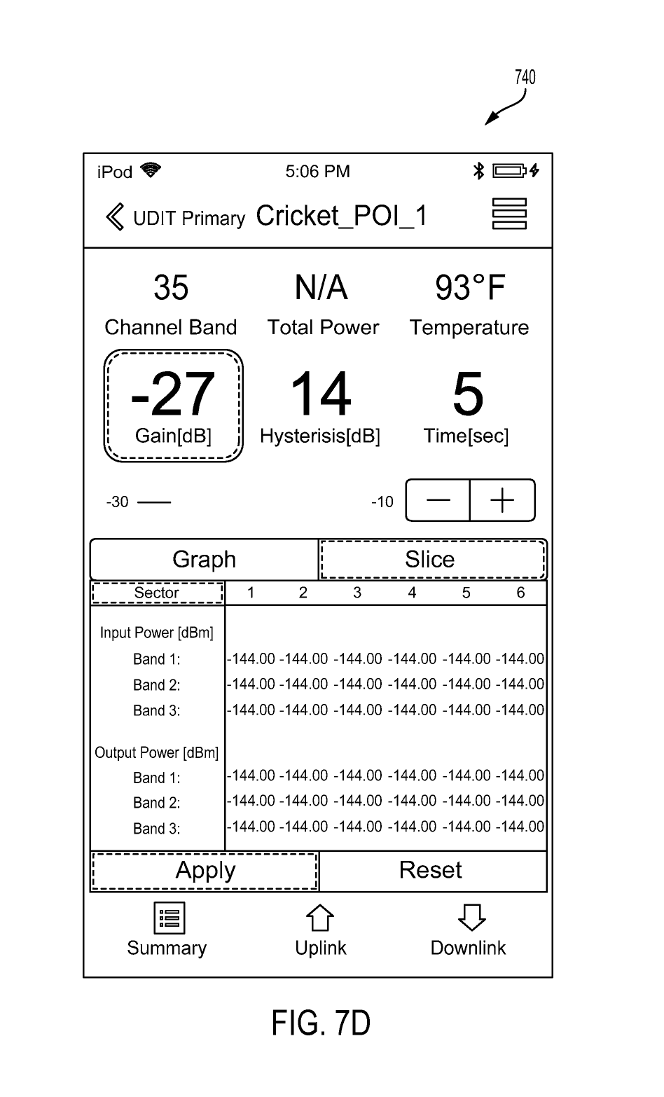

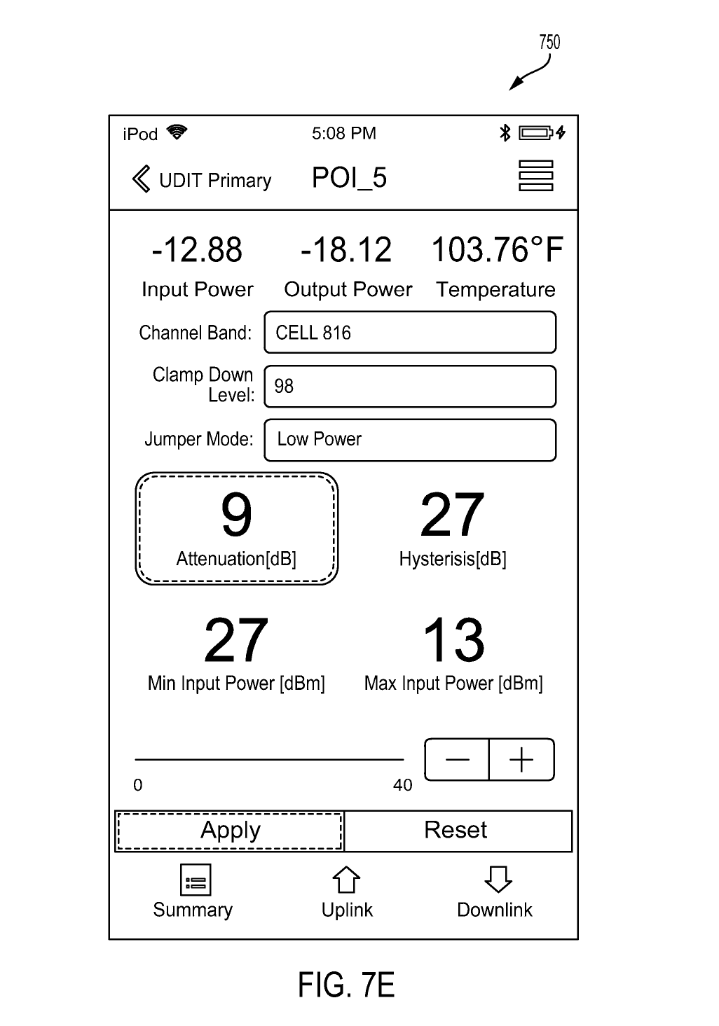

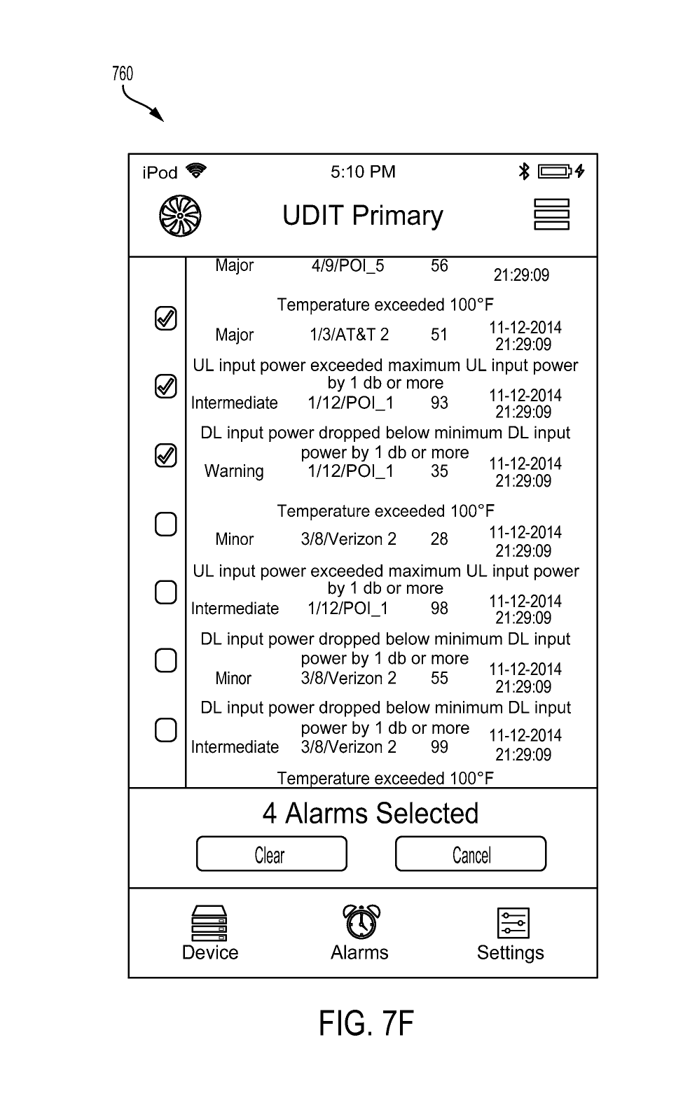

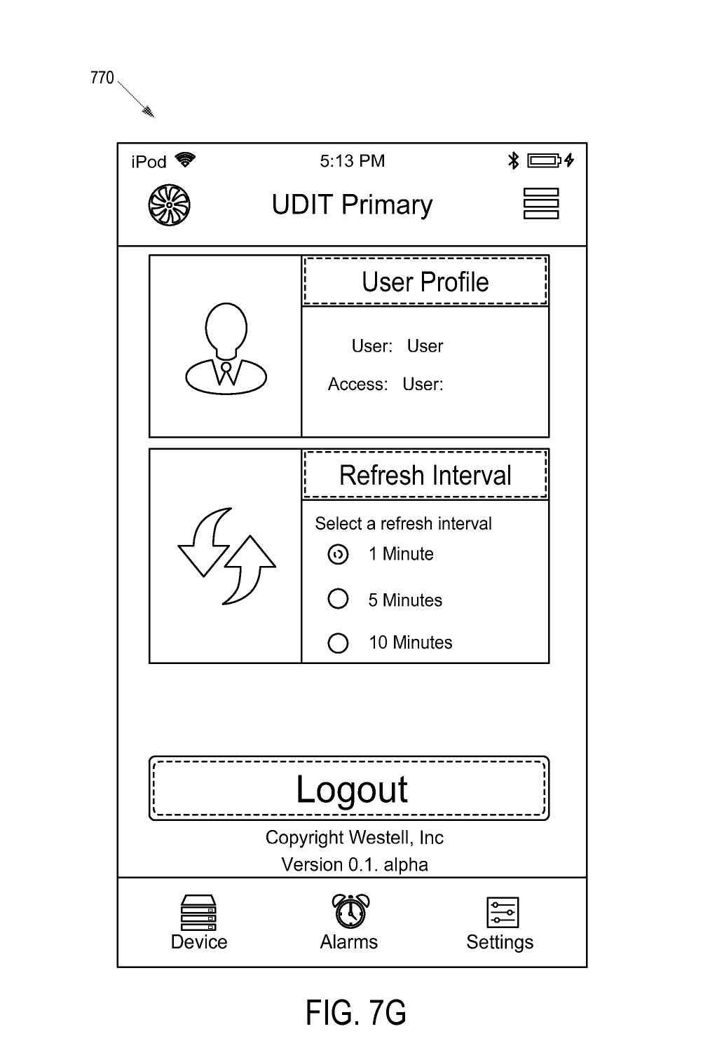

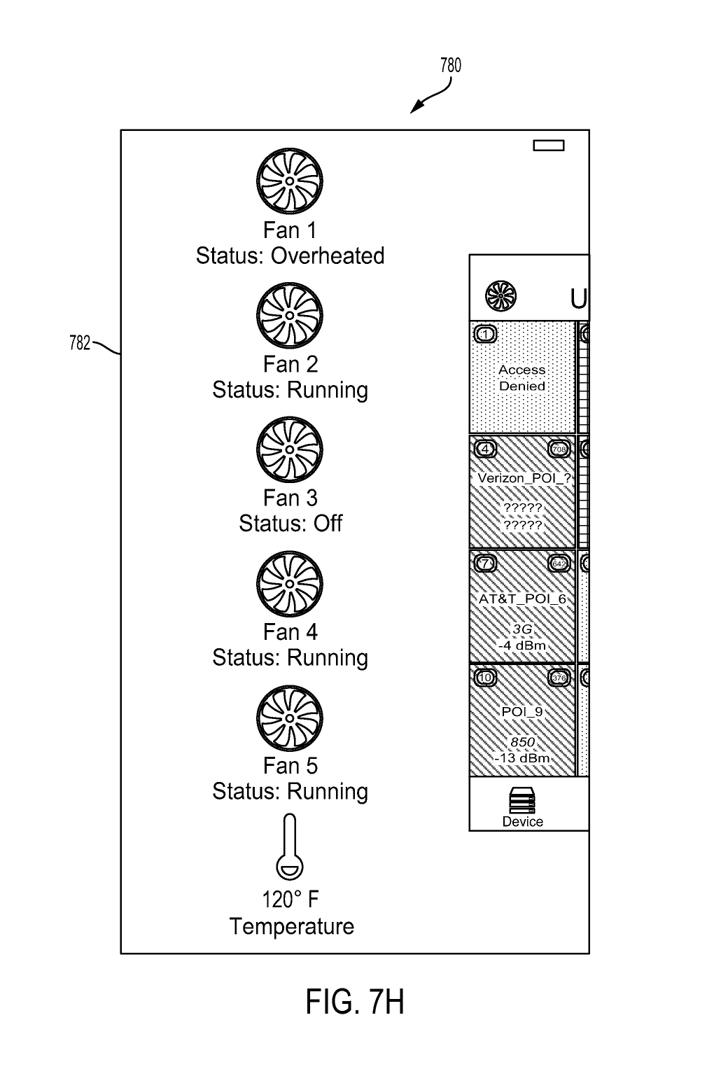

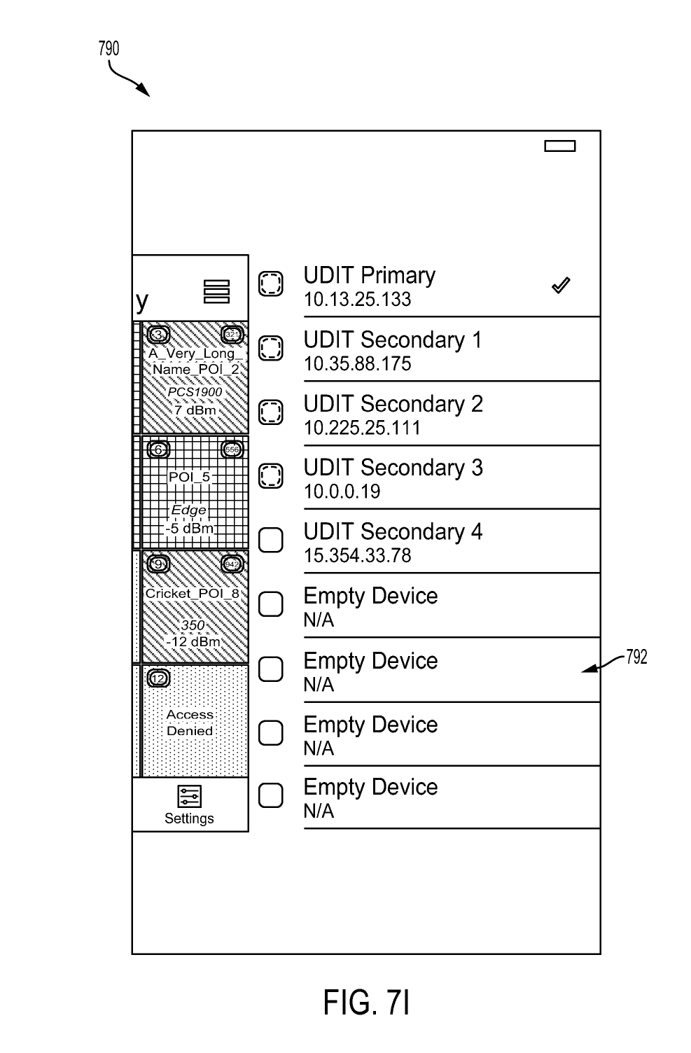

FIGS. 2 to 6E show screens from an exemplary GUI, which may be implemented on a larger touch-based interface, such on the touchscreen of a tablet computer. FIGS. 7A to 7I show screens from another example GUI, which may be implemented on a smaller touch-based interface, such as on the touchscreen of a mobile phone. However, it should be understood that the illustrated examples are not limited to any particular touch-based devices, and may both be implemented on touch-based devices having touchscreens of various different sizes.

Further, an example touchscreen application could be configured to provide both interfaces, and accordingly could switch between the GUI shown in FIGS. 2 to 6E, and the GUI shown in FIGS. 7A to 7I. For example, the application could display the GUI shown in FIGS. 2 to 6E when the touchscreen device is held in a landscape orientation, and could switch to the GUI shown in FIGS. 7A to 7I when the device is held in a landscape orientation. Other examples are also possible.

A. Illustrative Login Screen

FIG. 2 illustrates a login screen 200 according to an example embodiment, which may be displayed when an application for accessing a DAS-interface device opens on a touchscreen device. The screen 200 may provide fields for entering a user name and password, and possibly other information as well. For example, login screen 200 also includes a field allowing a user to enter the IP address or host name of the DAS-I device that they would like to access via the touch-based application. Login screen 200 further includes check boxes via which a user can request write permission and can indicate to save their credentials (e.g., username, password, and/or IP address).

Note that a DAS-I system may be set up for different types of users, which have varying levels of access to and control of the DAS-I system. Accordingly, the information and features provided by an example touch-based GUI may vary according to the user level of the particular user that logs in via the application.

For example, when a user logs in, an example application may determine whether the user is a guest, tenant, or owner of the DAS-I system or systems that the user wishes to access via the application. For instance, a DAS-I system may support access by three types of users: a guest, an owner, and a tenant. A guest user may be provided with read-only (i.e., viewing) access to the DAS-I system via the GUI. An owner may be provided access to all information and features of the DAS-I system, including, not limited to: read access, changing the password for the administrative level, changing the equipment operating parameters of the DAS-I system, changing the system setting and configuration for the of the DAS-I system, and/or creating, deleting, and/or, modifying user accounts for the DAS-I system. A tenant may be provided with read access, and some, but not all, of the functionality that is provided to an owner. For example, a tenant may have all the same capabilities as an owner, except for creating, deleting, and/or, modifying user accounts and software-upgrade privileges. It should be understood that other types of users and/or variations on the types of users described herein are possible.

B. Illustrative Touch-Based GUI

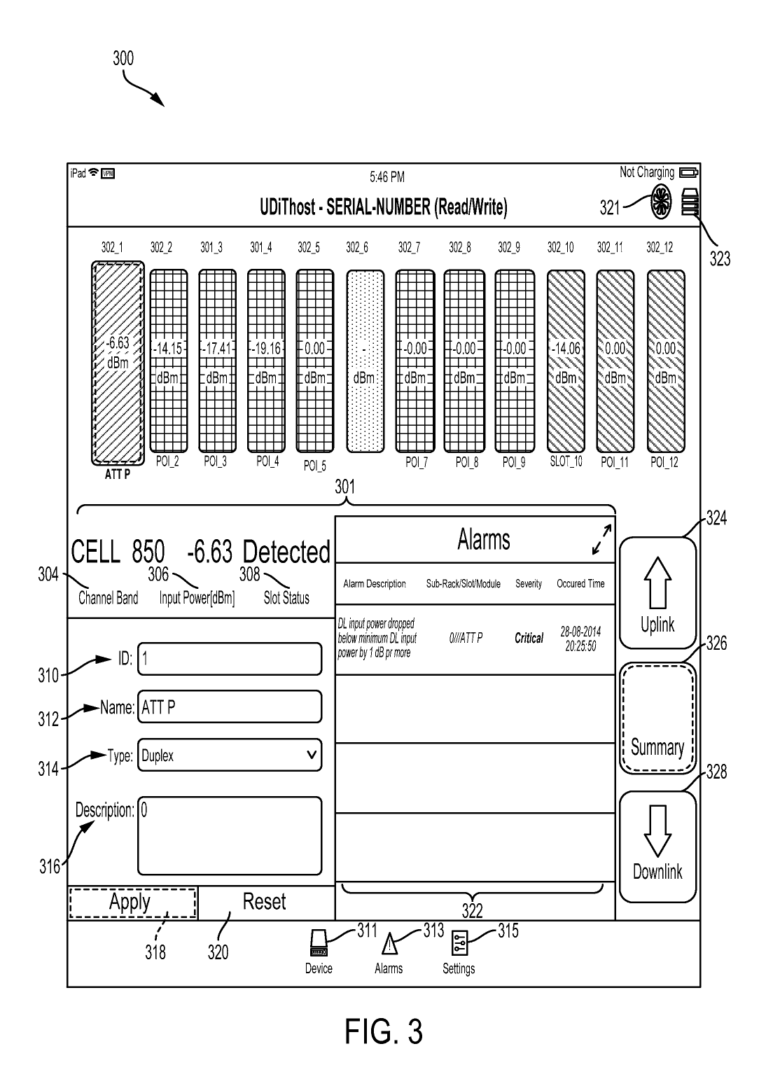

Once a user has logged in, the application may display a GUI on the device's touchscreen. The GUI may include features that provide information related to, and control of at least one DAS-interface device. For example, FIG. 3 shows a screen 300 from an example GUI, which may be shown once a user logs in.

An example GUI includes a plurality of point-of-interface (POI) slot icons, with each POI slot icon corresponding to at least one of a plurality of POI modules of a DAS-I system that is currently associated with the application. For example, screen 300 includes POI slot icons 302_1 to 302_12. Further, the GUI may include a name label for each POI slot icon 302_1 to 302_12. For instance, in the illustrated example, POI slot icon 302_1 is labeled with the name “ATT P,” POI slot icon 302_2 is labeled with the name “POI_2” (which may be a default naming convention), and so on.

An example GUI may additionally or alternatively include an input-power label for one or more of POI slot icons 302_1 to 302_12. The input power label for a given POI slot may indicate the input power at the input port of the DAS-I device that corresponds to the POI slot. For instance, in the illustrated example, POI slot icon 302_1 includes an input power label that reads “−6.63 dBm,” POI slot icon 302_2 includes an input power label that reads “−10.35 dBm,” and so on. To provide a specific example, if a BTS is connected to the port corresponding to POI slot icon 302_1, then the input-power label of POI slot icon 302_1 indicates that the input power from the BTS, at the DAS-I device, is −6.63 dBm. Other examples are also possible.

In a further aspect, the application may be configured to receive touch-based input data that indicates the selection of a particular one of the POI slot icons 302_1 to 302_12. For instance, to select a given one of POI slot icons 302_1 to 302_12, a user may tap the touchscreen at a location where the given POI slot is displayed. In response to the touch input data indicating the selection of a particular POI slot from the plurality of POI slots, the selected POI slot may be visually identified. For example, in screen 300, POI slot icon 302_1 is enlarged as compared to POI slot icons 302_2 to 302_12, and is outlined, in order to indicate that POI slot icon 302_1 is selected. Other ways of indicating a selected POI slot are also possible.

In a further aspect, an example touch-based GUI may include a control panel that includes touch-based controls corresponding to the selected POI slot. In the illustrated example, a control panel 301 is displayed on the same screen 300 as the POI slot icons 302_1 to 302_12. In other embodiments, the entire control panel 301 or portions thereof may be displayed on a different screen from the POI slots.

In example embodiments, the GUI may include one or more mode buttons that allow a user to switch between two or more modes of the control panel using touch input. For instance, the two or more modes may include two or more of an uplink mode, a summary mode, and a downlink mode. In the example shown in FIG. 3, the GUI includes an uplink mode button 324, a summary mode button 326, and a downlink mode button 328.

In response to touch input data indicating to provide a summary mode in the control panel, the control panel may be updated to display summary information and features corresponding to the currently selected POI slot. For instance, summary information and features may be displayed in control panel 301 when a user taps summary button 326. Further, in screen 300, the summary button 326 is highlighted; indicating that the control panel 301 is currently in the summary mode.

C. Illustrative Touch-Based GUI—Summary Mode

Screen 300 is an example of a GUI in a summary mode. In summary mode, the control panel 301 may include one or more features corresponding to the selected POI slot icon 302_1. Examples of such features include, but are not limited to, one or more of: (a) an alarm panel 322, (b) an input power indication 304, (c) a channel band indication 306, and/or (d) a status indication 308. The alarm panel 322 may include a list of alarms and/or other types of notifications related to the selected POI slot icon 302_1. The input power indication 304 may indicate the input power at the input port of the DAS-I device that corresponds to the selected POI slot icon 302_1 (e.g., the input power from the BTS or other signal source connected to the corresponding port). The channel band indication 306 may indicate the particular channel band. Further, the status indication 308 may indicate, e.g., the status of the input device that is connected the input port of the DAS-I device that corresponds to the selected POI slot icon 302_1 (e.g., whether or not an input signal is detected at the corresponding port).

In a further aspect of a summary mode, the control panel 301 may include one or more fields corresponding to the selected POI slot. For instance, in screen 300, the control panel 301 includes (a) an ID field 310, (b) a name field 312, (c) a type field 314, and (d) a description field 316 (e.g., which can be used to input and store notes or other information related to the selected POI slot icon 302_1.

The ID field 310 includes an identifier for the currently selected slot. For example, in screen 300, ID field 310 indicates “1”, which is the identifier for the currently selected slot 302_1. Note that the GUI may also show the identifier for all slots in the portion of the screen that includes the POI slots (e.g., identifiers 1 to 12 shown above POI slot icons 302_1 to 302_12, respectively). Further, note that the ID field 310 may be filled based on identifiers that are pre-defined and fixed, such that the user cannot change the identifiers. In other embodiments, however, such identifiers could alternatively be user-definable.

In some embodiments, some or all of the fields in a control panel may allow the user to change parameters and/or attributes of the selected POI slot. In some cases, a user may select a text-based field by tapping on the field, and may then use a touch-based keyboard or a voice dictation to enter text into the selected text-based field. As just one example, referencing screen 300, a user may tap name field 312 in order to type or speak a new name for the currently selected POI slot. In some embodiments, a user may edit a textual description in description field 316 in a similar manner as the user can edit the text in name field 312. Other examples are also possible.

In some cases, a user may select a drop-down field by tapping on the field, which causes a drop-down list of multiple options to be displayed on the touchscreen. The user may then select one of the options by, e.g., tapping on the particular option. As just one example, referencing screen 300, a user may tap type field 314 in order to bring up a pre-determined list of possible types for a POI slot. For instance, possible POI-slot types may include “single” (e.g., a single input signal received at a single input port), and “duplex” (e.g., where input from a single BTS is split and sent to two POI modules), among other possibilities.

Further, the control panel 301 may include an apply button 318 and a reset button 320. The apply button may apply settings that have been updated in the GUI, such that the operation of the DAS-I system is modified in accordance with the updated settings. For example, if the user has updated the name field 312, type field 314, and/or description field 316 in the GUI, the updated values for these fields may be stored when the user taps the apply button 318. Other examples are also possible.

The reset button 320 may reset fields and/or features to a certain state. For example, when summary button 326 is tapped, the control panel 301 may initially show the currently-stored values for name field 312, type field 314, and description field 316. If these fields are updated in the GUI, but not stored using the apply button 318, then the user may tap the reset button 320 to restore the currently-stored values for these fields. Other examples are also possible.

D. Illustrative Touch-Based GUI—Uplink Mode

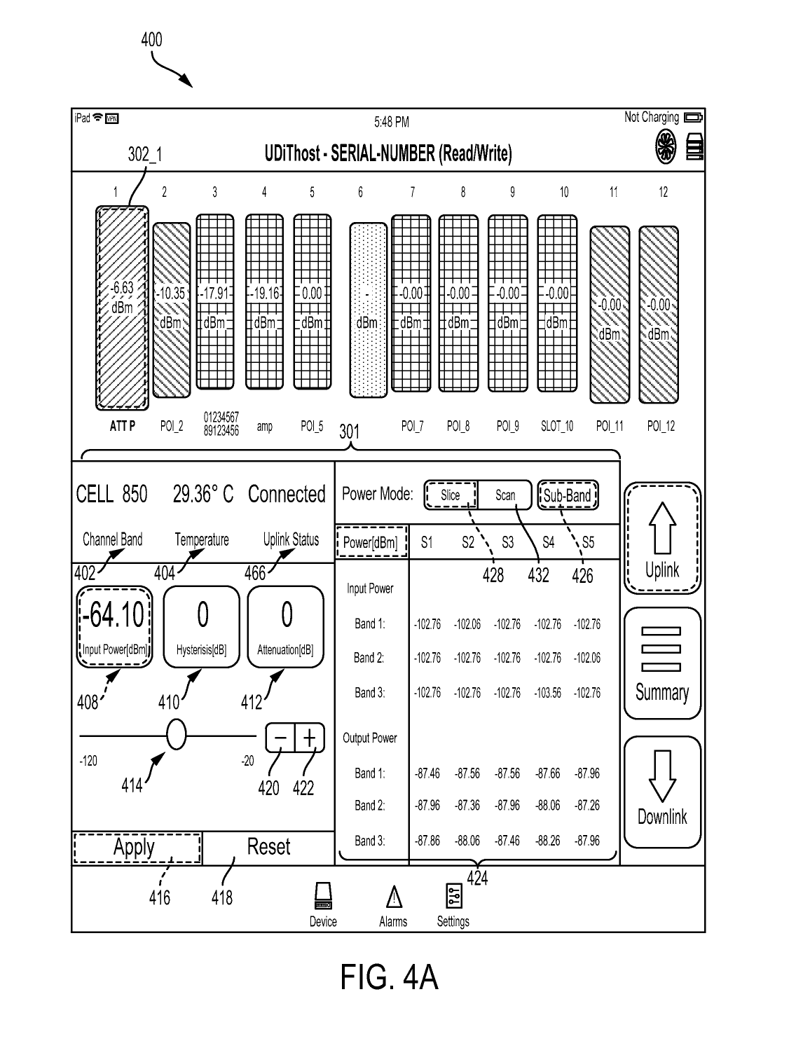

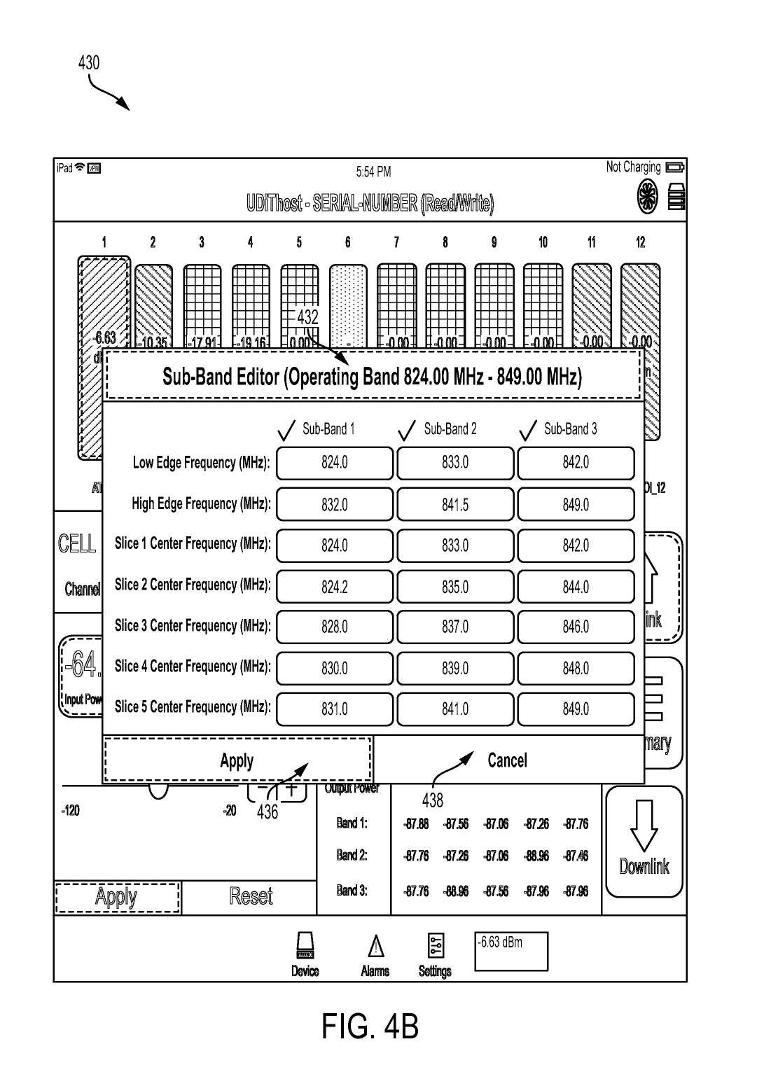

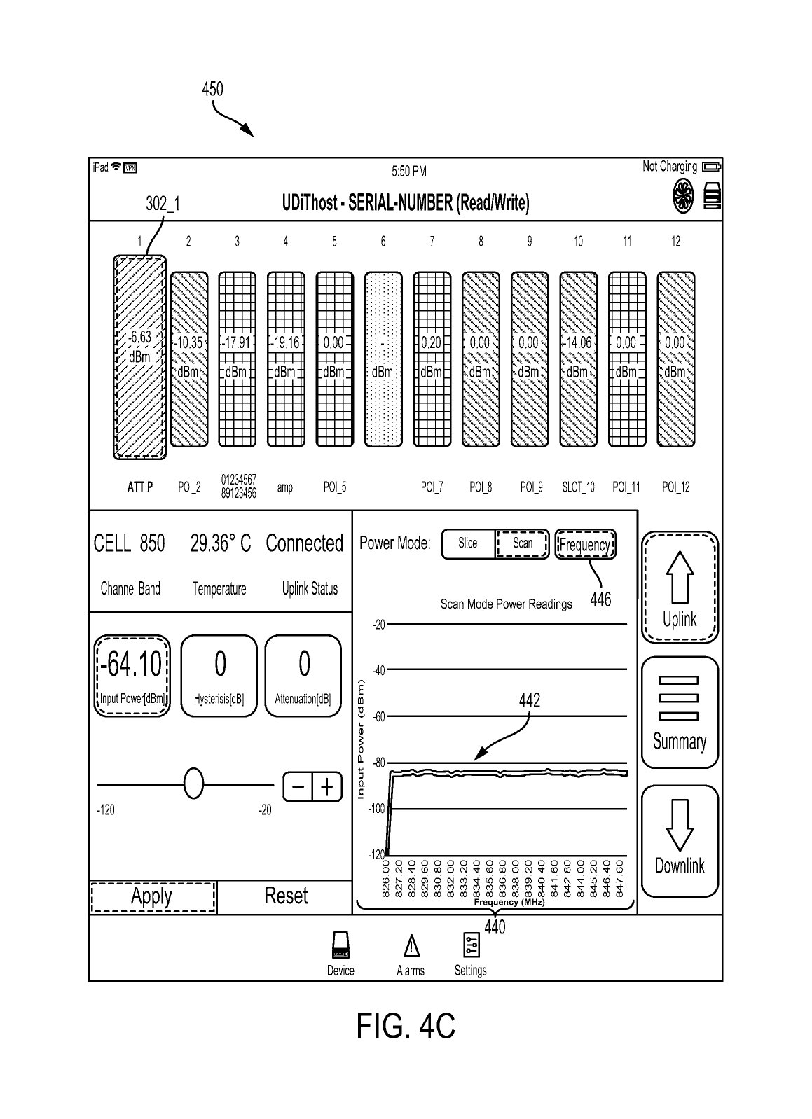

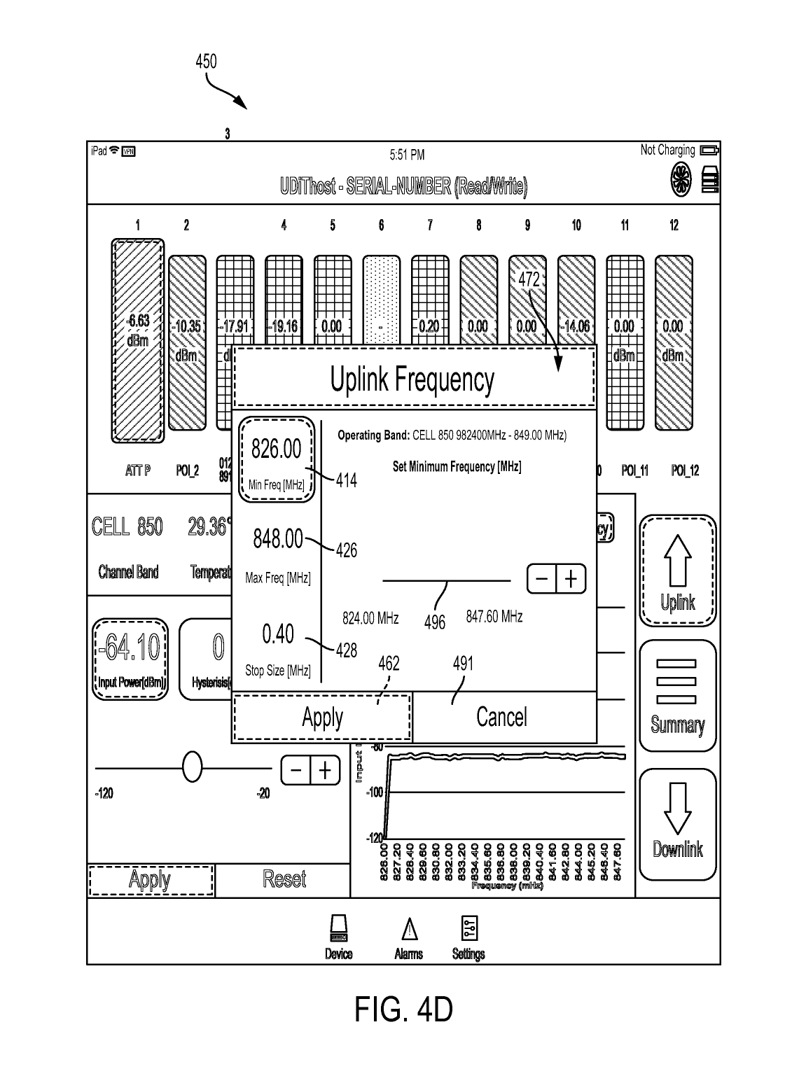

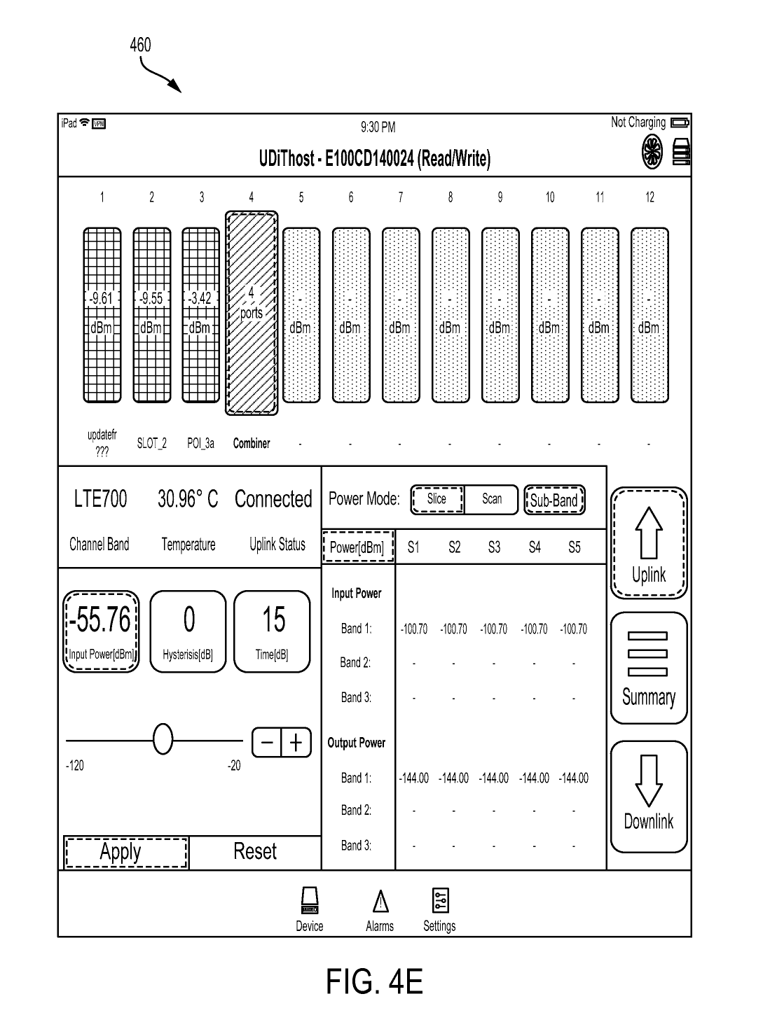

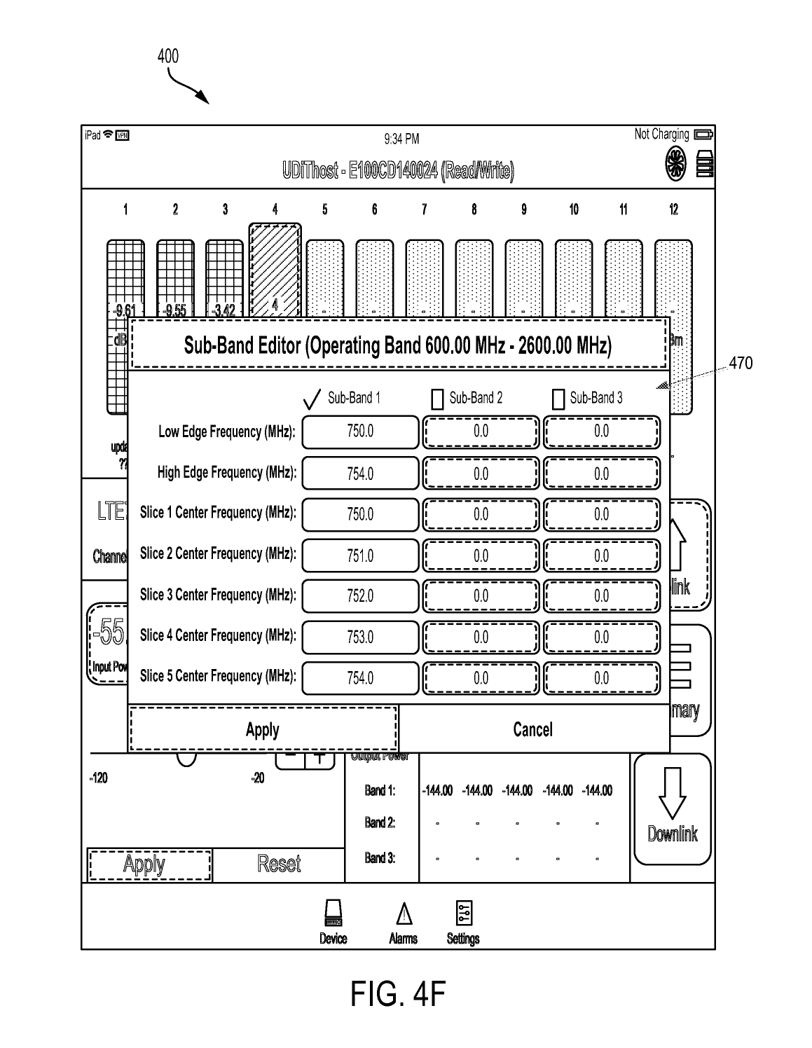

In response to touch input data indicating to provide an uplink mode in the control panel, the control panel may be updated to display uplink information and/or uplink features corresponding to the selected POI slot. For instance, FIGS. 4A to 4D show screens 400, 430, 450, and 470, respectively, which includes uplink information and features. A screen such as screen 400 or screen 450, or another type of screen, may be displayed when a user taps uplink button 324. Further, in screens 400, 430, 450, and 470, the uplink button 324 is highlighted, which indicates that the control panel 301 is currently in the uplink mode.

In uplink mode, the control panel 301 may include one or more uplink features corresponding to the selected POI slot icon 302_1. Examples of such features include, but are not limited to, one or more of: (a) a channel band indication 402, (b) a temperature indication 404, and (c) a status indication 406.

The channel band indication 402 specifies, for example, the name of the operating band for which the POI module corresponding to the selected POI slot icon is configured. For example, in screen 300, the channel band indication 402 reads “CELL 850.” This indicates that the name of the operating band for which the uplink path of the corresponding POI module is configured, is “CELL 850.” Other examples are of course possible.

The temperature indication 404 may indicate a temperature reading corresponding to the uplink processor for the slot of DAS-I system that corresponds to the selected POI slot icon. For example, screen 400 indicates that the temperature reading at the uplink processor for the slot of DAS-I system that corresponds to the selected POI slot icon 302_1 is 29.36° C. Other examples are also possible.

The status indication 406 may indicate, e.g., the status of the uplink channel band on the slot of the DAS-I device that corresponds to the selected POI slot icon 302_1 (e.g., whether or not an uplink channel is established between the source device and the DAS-I device).

In a further aspect of an uplink mode, the control panel 301 may include one or more adjustable uplink fields corresponding to the selected POI slot. For instance, in screen 400, the control panel 301 includes (a) an input power control feature 408, (b) a hysteresis control feature 410, and (c) an attenuation control feature 412. The input power control feature 408 may provide for touch-based control of the threshold input power for the uplink signal path of the corresponding POI module, such that an alarm will be generated if the uplink-path input power (e.g., from a remote unit of the DAS or DAS-I head unit) exceeds the threshold set via input power control feature 408. Additionally, the attenuation control feature 412 may allow the user to adjust the uplink attenuation for the downlink path of the POI module corresponding to the currently selected POI slot icon.

Further, the hysteresis control feature 410 may provide the user with touch-based remote control of the alarms for the corresponding DAS-I system. For example, screen 400 shows an example where the user has set the threshold input power to −64.10 dBm, and has set the Hysterisis as 0 dbm. With such a configuration on the corresponding DAS-I system, an alarm will be generated if the uplink input power increases to −60 dBm, and thus exceeds the threshold input power. Further, the alarm will remain in the system until the current input power values drops to at least the threshold value. Further, since the Hysterisis value is 0 dBm, the alarm will be automatically cleared as soon the current input power value reaches the threshold input power value of 64.10 dBm. Other examples are also possible.

In the illustrated example, screen 400 may allow a user to adjust the setting of uplink fields such as input power control feature 408, a hysteresis control feature 410, and attenuation control feature 412. For instance, in screen 400, the control panel 301 includes a touch-operable slider feature 414. Further, in screen 400, input power control feature 408, a hysteresis control feature 410, and attenuation control feature 412 each take the form of a touch-operable button graphic. As such, the user may tap the button to select the particular control feature that the user would like to adjust, and then use the slider feature 412 to adjust the uplink parameter corresponding to the selected control feature. For example, on screen 400, the input power control feature 408 is currently selected (as indicated by the darker color of input power control feature 408, as compared to hysteresis control feature 410 and attenuation control feature 412). As such, the user may touch and swipe the slider feature 412 in order to adjust the threshold input power for the uplink of the POI module corresponding to the selected POI slot icon 302_1.

In a further aspect, panel 301 includes “+” button 420 and “−” button 422, which may provide alternate way for the user to control the slider (and thus to control the selected control feature 408, 410, or 412). In particular, the user may tap the “+” button 420, to increase the value of the uplink parameter corresponding to the selected control feature (e.g., or move the slider feature 414 to the right), and may tap the “−” button 422 to decrease the value of the selected control feature (e.g., or to move the slider feature 414 to the left). While duplicative input features, such as “+” button 420 and “−” button 422, are not required, there may be benefits to providing two or more types of input features to control the same parameter. For example, the slider feature 414 may be useful to quickly make larger adjustments to a parameter, while the additional “+” button 420 and “−” button 422 may provide more control over smaller adjustments, thus allowing for more fine-tuned control of an uplink parameter. Other examples are also possible.

Further, in FIG. 4A, the control panel 301 include an apply button 416 and a reset button 418. The apply button 416 may apply settings that have been updated in the GUI, such that the operation of the DAS-I system is modified in accordance with the updated settings. The reset button 418 may restore the features in the GUI such that they indicate values that were measured by the DAS-I system (if the user has changed the values in the GUI).

In a further aspect of the uplink mode, the control panel may provide a power information panel 424, which includes input and output power information for the slot of the DAS-I system corresponding to the selected POI slot icon 302_1. In the illustrated example, power information panel 424 includes input and out power data for the operating band indicated by channel band indication 402. In particular, the operating band (e.g., for a sector) may be divided into sub-bands, and each sub-band may be further divided into slices. In the illustrated example, power information panel 424 divides the operating band into three sub-bands (Bands 1 to 3), and divides each sub-band into five slices S1 to S5. As such, power information panel 424 indicates the input power and corresponding output power for each of the five slices S1 to S5 for each of the three sub-bands (Bands 1 to 3).

The power information panel 424 may help a user to evaluate how changes to the settings of the DAS-I system effect uplink input and output power. For example, when the uplink threshold input power is adjusted (e.g., via channel band indication 402) the input power values shown in power information panel 424 may be updated accordingly. As another example, when the uplink path attenuation is adjusted (e.g., via hysteresis feature 410) the output power values shown in power information panel 424 may be updated accordingly.

In an example embodiment, a user can edit the parameters of the channel bands (e.g., Bands 1 to 3) for which power information is displayed in power information panel 424. For example, when power information panel 424 shows per-sector channel band input and/or output power, such as on screen 400, the control panel 301 may also include a sub-band button 426. The user may tap on sub-band button 426 in order to display an interface for adjusting one or more parameters of the bands shown in power information panel 424.

For example, when screen 400 is displayed, and the touchscreen device detects a tap on sub-band button 426, the touchscreen device may responsively open a parameter adjustment window. An example of such a parameter adjustment window is shown in FIG. 4B. In particular, FIG. 4B shows a screen 430, where a parameter adjustment window 432 is displayed over the screen shown in FIG. 4A.

The parameter adjustment window 432 may provide a touch-based interface via which a user can adjust various parameters of the sub-bands for the power information panel 424. In the illustrated example, the user may input values for each Sub-Band 1 to 3. Specifically, for each Sub-Band 1 to 3, the user may input values (e.g., in MHz) for the low edge frequency, the high edge frequency, the slice 1 center frequency, the slice 2 center frequency, the slice 3 center frequency, the slice 4 center frequency, and the slice 5 center frequency. The center frequencies may be adjusted to set the frequency range for each sub-band 1 to sub-band 3, and to set the particular frequencies at which the input and output power is measured for each slice 1 to 5 of each sub-band 1 to 3.

Further, in FIG. 4B, the parameter adjustment window 432 includes an apply button 436 and a cancel button 438. Tapping the apply button 436 may apply settings that have been updated in the GUI, such that the operation of the DAS-I system is modified in accordance with the updated settings. Once the updated parameters are applied, the parameter adjustment window 432 may close, and screen 400 may be fully displayed again. Further, the input and output power information in the power information panel 424 may be updated based on the parameters that were adjusted via the parameter adjustment window 432. Tapping the cancel button 438 may close the parameter adjustment window 432 without applying any updates to the parameters (and thus without making any changes to the operation of the DAS-I system).

In a further aspect, the power information panel 424 may have multiple sub-modes within the uplink mode. Accordingly, an example GUI may provide touch-operable features that allow a user to switch between the sub-modes of the power information panel 424. For instance, in the illustrated example, the control panel may include a scan button 431, in addition to the slice button 428. The scan button 431 and the slice button 428 may allow the user to switch between: (a) viewing the power information panel 424 with sub-band input-output power information (as shown on screen 400), and (b) viewing a spectrum analyzer panel 440, as shown in FIG. 4C.

In particular, FIG. 4C shows a screen 450 of an example uplink mode, which includes a spectrum analyzer panel 440 in the control panel. In this example, the spectrum analyzer panel 440 includes a graph 442 of scan mode power readings for the slot of the DAS-I system corresponding to the selected POI slot icon 302_1. The graph 442 shows the input power (in dBm) as a function of frequency (in MHz) for the slot corresponding to the selected POI slot icon 302_1.

In an example embodiment, the GUI may allow a user to edit the parameters that are used for the scan mode power readings that are visualized in the graph 442. For example, when graph 442 is displayed, the control panel 301 may also include a frequency button 446. As such, the user may tap on frequency button 446 in order to display an interface for adjusting one or more parameters for the scan mode power readings.

For example, when screen 450 is displayed, and the touchscreen device detects a tap on frequency button 446, the touchscreen device may responsively open a parameter adjustment window. An example of such a parameter adjustment window is shown in FIG. 4D. In particular, FIG. 4D shows a screen 470, where a parameter adjustment window 472 is displayed over the screen shown in FIG. 4C.

The parameter adjustment window 472 may provide a touch-based interface via which a user can adjust various parameters affecting graph 442. In the illustrated example, the user may input values for a minimum frequency parameter, a maximum frequency parameter, and a step size parameter. As such, the user may tap one of the buttons 474 to 476, to select one the minimum frequency parameter, the maximum frequency parameter, or the step size parameter, respectively. The slider feature 480 may then be used to adjust the selected parameter; e.g., by touching slider feature 480 and then swiping to the left or right on the touchscreen to move the slider feature left or right, respectively.

Further, in FIG. 4D, the parameter adjustment window 472 includes an apply button 482 and a cancel button 484. Tapping the apply button 482 may apply settings that have been updated in the GUI, such that the operation of the DAS-I system is modified in accordance with the updated settings. Once the updated parameters are applied, the parameter adjustment window 472 may close so screen 450 is fully displayed again. Further, the graph 442 may be updated based on the parameters that were adjusted via the parameter adjustment window 472. Tapping the cancel button 484 may close the parameter adjustment window 472 without applying any updates to the parameters (and thus without making any changes to the operation of the DAS-I system).

In a further aspect, FIGS. 4E and 4F illustrate a screen and a parameter adjustment window an example GUI that provide control over the uplink path of a POI slot icon 302_4 corresponding to a combiner module of the DAS-I system. In the illustrated example, four ports are combined in the corresponding combiner module. The functionality provided via the screen 460 shown in FIG. 4E may be similar to the functionality discussed in reference to screen 400, but as applied to a combiner module instead of a single POI module. Similarly, the parameter adjustment window 470 shown in FIG. 4F may provide similar functionality to that discussed in reference to parameter adjustment window 432, but as applied to a combiner module instead of a single POI module. (Note that as such, the uplink channel band may be divided into slices, but not into multiple sub-bands.)

D. Illustrative Touch-Based GUI—Downlink Mode

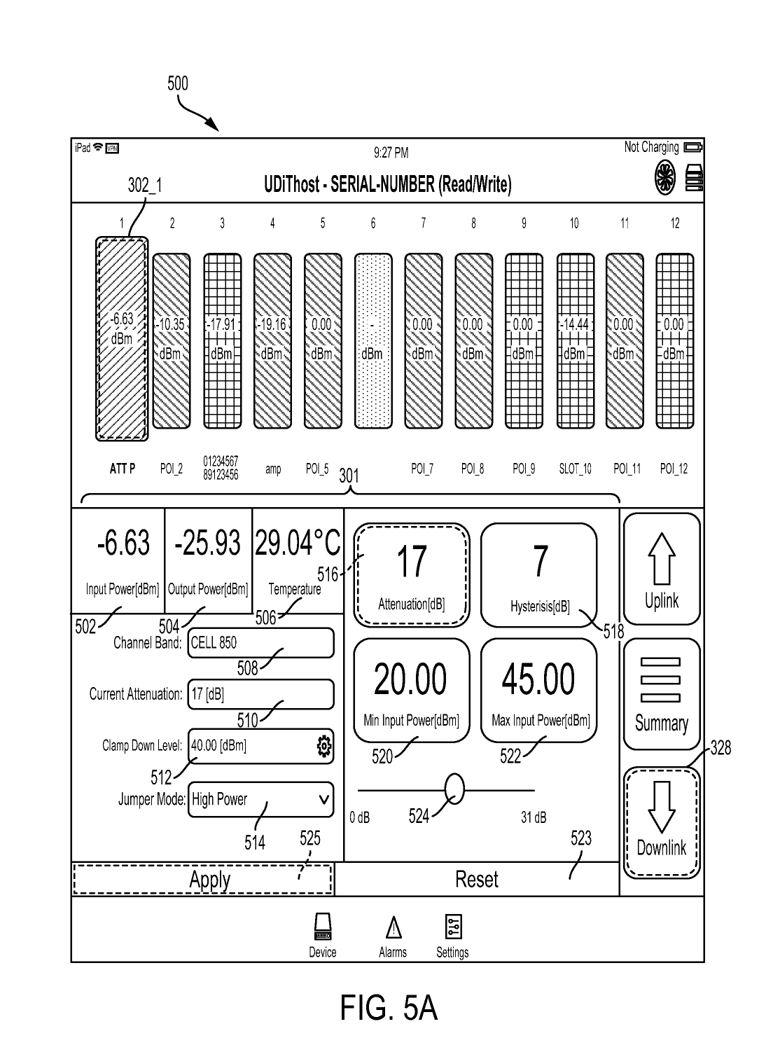

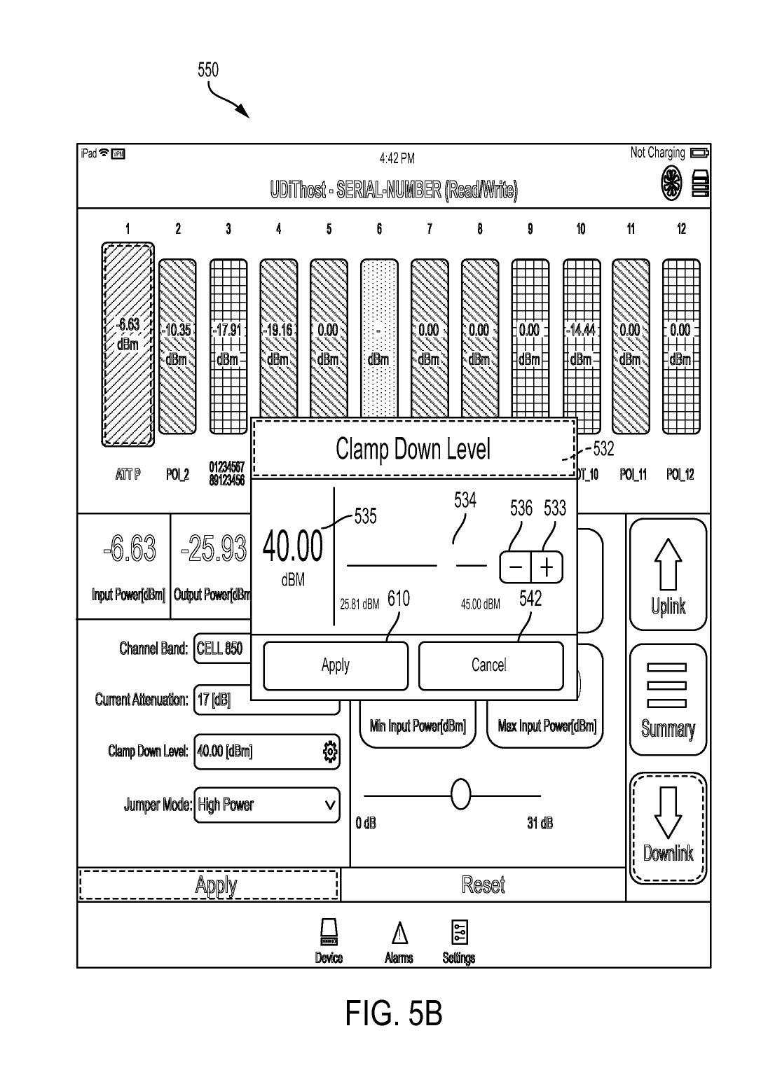

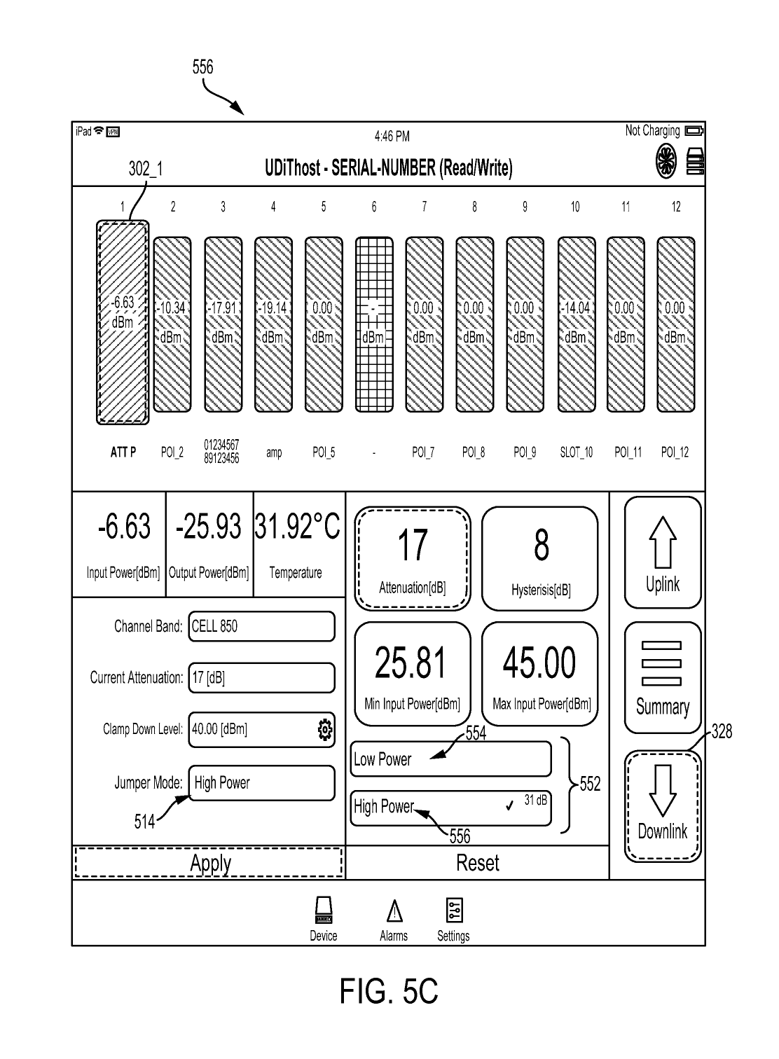

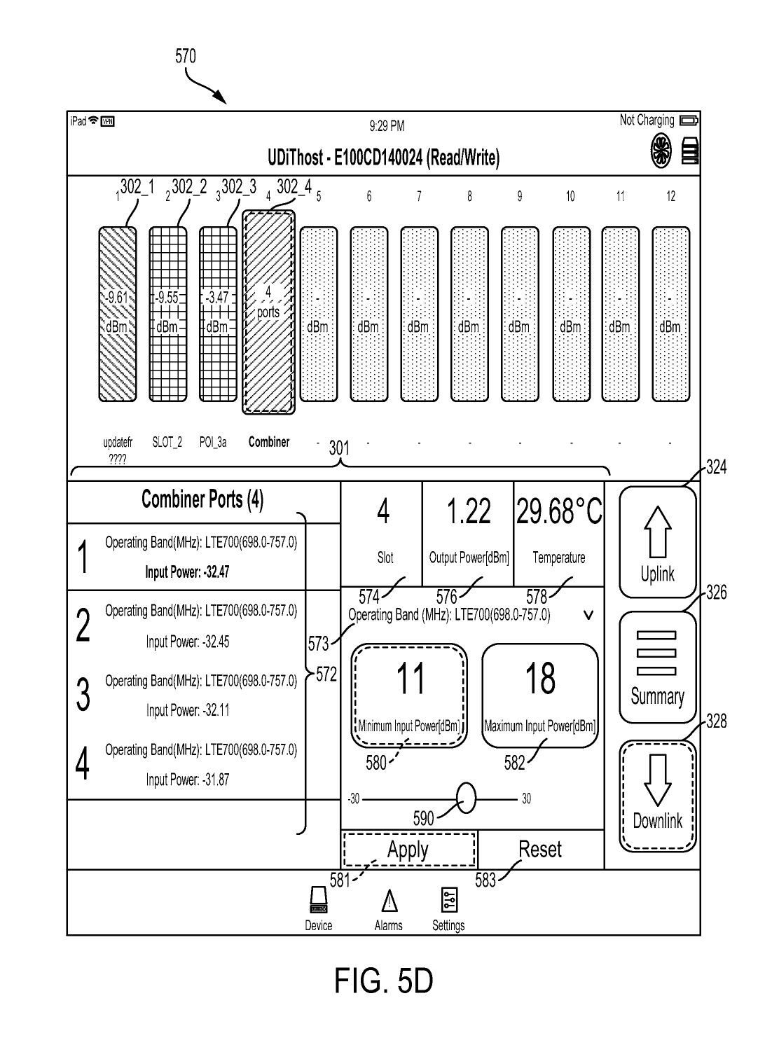

In response to touch input data indicating to provide a downlink mode in the control panel, the GUI may be updated to display downlink information and/or downlink features for the slot of the DAS-I system corresponding to the selected POI slot icon. For instance, FIGS. 5A to 5D show screens 500, 530, 550, and 570, respectively, which include downlink information and features. A screen such as screen 500 or screen 570, or another type of screen, may be displayed when a user taps the downlink button 328. Further, in screens 500, 530, 550, and 570, the downlink button 328 is highlighted, which indicates that the control panel 301 is currently in the downlink mode.

Referring to FIG. 5A, in a downlink mode, the control panel 301 may include one or more downlink features corresponding to slot of the DAS-I system represented by the selected POI slot icon 302_1. Examples of such features include, but are not limited to, one or more of: (a) an input power indication 502, (b) a temperature indication 506, and (c) an output power indication 504. The input power indication 502 may indicate the power level at the input to the downlink path of the corresponding POI module (e.g., at the POI to the BTS that is connected to the corresponding POI module). Further, the output power indication 504 may indicate the power level at the output of the downlink path of the corresponding POI module (e.g., to the DAS).

The temperature indication 506 may indicate a temperature reading corresponding to the downlink processor for the slot of DAS-I system that corresponds to the selected POI slot icon. For example, screen 500 indicates that the temperature reading at the downlink processor for the slot of DAS-I system that corresponds to the selected POI slot icon 302_1 is 29.04° C. Other examples are also possible.

In a further aspect of a downlink mode, the control panel 301 may include one or more adjustable downlink fields corresponding to the selected POI slot icon 302_1. For instance, in screen 500, the control panel 301 includes (a) a channel band field 508, (b) a current attenuation field 510, (c) a clamp down level field 512, and (d) a jumper mode field 514. As noted above, some or all of the fields in a control panel may allow the user to change parameters and/or attributes of the slot corresponding to the selected POI slot icon 302_1.

In the illustrated example, the channel band field 508 may indicate the operating band of the BTS that is connected to the POI module corresponding to the currently selected POI slot icon. For example, in screen 500, channel band field 508 indicates that “CELL 850” which is the name of the operating band assigned to POI module corresponding to the currently selected slot 302_1.

Example embodiments may allow a user to update the value in the clamp down level field 512 in various ways. As just one example, when screen 500 is displayed, a user may tap the clamp down level field 512 to bring up a parameter adjustment window for the field. An example of such a parameter adjustment window is shown in FIG. 5B. In particular, FIG. 5B shows a screen 530, where a parameter adjustment window 532 is displayed over the screen shown in FIG. 5A.

The parameter adjustment window 532 may provide a touch-based interface via which a user can adjust the clamp down level 535. In the illustrated example, the slider feature 534 may be used to adjust the clamp down level 535; e.g., by touching slider feature 534 and then swiping to the left or right on the touchscreen to move the slider feature 534 left or right, respectively.

In a further aspect, parameter adjustment window 532 includes “+” button 538 and “−” button 536, which may provide alternate way for the user to control the slider feature 534 (and thus to control the clamp down level). In particular, the user may tap the “+” button 538, to increase the clamp down level (e.g., to move the slider feature 534 to the right), and may tap the “−” button 536 to decrease the clamp down level (e.g., to move the slider feature 534 to the left). As noted above, such duplicative input features are not required, but may provide benefits, such as allowing for more fine-tuned control of adjustments to the clamp down level.

Further, in FIG. 5B, the parameter adjustment window 532 includes an apply button 540 and a cancel button 542, which may function in the same or similar manner as apply and cancel buttons described elsewhere herein in reference to other parameter adjustment windows.

Referring again to screen 500, in a further aspect, the jumper mode field 514 may allow the user to select between various predetermined settings for a jumper mode parameter. In the illustrated example, the jumper mode field 514 is a drop-down field. As such, when a user taps the jumper mode field 514, the touchscreen device may responsively display a list of multiple options for the jumper mode field 514.

An example of a list for the jumper mode field 514 is shown in FIG. 5C. In particular, FIG. 5C shows a screen 550, where a jumper mode list 552 is displayed over the screen shown in FIG. 5A. In the illustrated example, the list 552 includes a “low power” block 554 and “high power” block 556, which correspond, respectively, to a low power setting and a high power setting. As such, a user may tap low power” block 554 or “high power” block 556, to set the value for the jumper mode field 514 to “Low Power” or “High Power,” respectively.

In a further aspect of the downlink mode, the control panel 301 may include one or more downlink selector features, corresponding to various aspects of the downlink of the slot of the DAS-I system represented by the selected POI slot icon 302_1. In screen 500, the control panel 301 includes (a) an attenuation control feature 516, (b) a hysteresis feature 518, (c) a minimum input power feature 520, and (d) a maximum input power feature 522. The attenuation control feature 516 may allow the user to adjust the downlink attenuation for the downlink path of the POI module corresponding to the currently selected POI slot icon.

Minimum and maximum input power features 520 and 522 may allow the user to specify the minimum and maximum downlink input power levels to be applied to the downlink path of the currently associated POI module, by the downlink power management feature(s) of the DAS-I system. Accordingly, if the downlink input power at the corresponding POI module drops below the lower threshold set via minimum input power feature 520, or rises above the upper threshold set via maximum input power feature 522, an alarm will be generated.

The hysteresis control feature 518 may allow the user to adjust the manner in which a DAS-I system clears alarms related to the downlink path of the POI module corresponding to the selected POI slot icon. For instance, screen 500 shows an example where the minimum and maximum threshold input power values are set to 20 dBm and 45 dBm, respectively, and where the hysteresis value is set to 7 dBm. If the current downlink-path input power value rises to 48 dBm with illustrated settings in place, the maximum threshold value is exceeded and the DAS-I system will generate an alarm. Further, consider a scenario where the current input power on the downlink subsequently drops to 40 dBm. In this scenario, due to the hysteresis setting of 7 dBm, the alarm will remain in the alarm list for the DAS-I system, even though the input power is now within the acceptable range established by the minimum and maximum input power settings (e.g., 20 to 45 dBm). In particular, the alarm will still remain in the system until the current downlink input power values drops to 38 dBm or lower, at which point the alarm would be cleared. Other examples are also possible.

In the illustrated example, screen 500 may allow a user to adjust the setting of downlink parameters via downlink selector features, such as attenuation control feature 516, hysteresis feature 518, minimum input power feature 520, and maximum input power feature 522. For instance, in screen 500, the control panel 301 includes a touch-operable slider feature 524. Further, in screen 500, attenuation control feature 516, hysteresis feature 518, minimum input power feature 520, and maximum input power feature 522 each take the form of a touch-operable button graphic. As such, the user may tap the particular feature corresponding to the downlink parameter that the user would like to adjust. The slider feature 524 can then be used to adjust the downlink parameter corresponding to the selected control feature. For example, on screen 500, the attenuation control feature 516 is currently selected (as indicated by the darker color of attenuation control feature 516). As such, the user may touch and swipe the slider feature 524 in order to adjust the attenuation indicated in the attenuation control feature 516.

Referring now to FIG. 5A the control panel 301 includes an apply button 525 and a reset button 523. The apply button 525 may apply settings that have been updated in the GUI, such that the operation of the DAS-I system is modified in accordance with the updated settings. The reset button 523 may restore the features in the GUI such that they indicate values that were measured by the DAS-I system (if the user has changed the values in the GUI).

In a further aspect, note that the current attenuation field 510 may be populated based on the actual attenuation of the DAS-I system. Thus, while attenuation control feature 516 may be updated as a user moves slider 524, current attenuation field 510 may not be updated until the user hits the apply button 525, and the DAS-I system updates the attenuation of the downlink on the slot corresponding to the selected POI slot icon 302_1.

As noted above, the DAS-I systems may allow for multiple input signals to be combined (e.g., divided or summed) in a single slot. Such a slot may be referred to as a “combiner” slot. Accordingly, an example touch-based GUI for controlling a DAS-I system may include a POI slot icon that represents a combiner slot. For example, FIG. 5D illustrates a screen 570 where one of the POI slot icons is assigned to a combiner slot.

In some embodiments, a POI slot icon for a combiner slot may indicate the number of ports that are combined in the slot. In the illustrated example, POI slot icon 302_4 indicates that there are four ports assigned to the corresponding combiner slot. Of course, the number of ports assigned to a given combiner slot may vary.

When other POI slot icons are selected, such as POI slot icon 302_1, the GUI may operate as described elsewhere herein; e.g., by providing summary, uplink, and/or downlink mode functionality described above. However, when the user taps POI slot icon 302_4, the GUI may provide at least some information and/or functionality that is designed specifically for combiner slots.

When the POI slot icon 302_4 is selected, the control panel 301 may display a port list, which provides information about the source devices that are connected to the particular ports that are combined. For instance, in screen 570, port list 572 indicates the operating band and input power for the respective source device that is connected to each port that is part of the combiner slot.

In screen 570, the control panel 301 further includes a port selection field 573. In the illustrated embodiment, port selection field 573 is a touch-operable drop-down field; however, other types of input features may also be used for port selection. The user may tap port selection field 573 in order to bring up a list of the ports that are combined in the combiner slot corresponding to the selected POI slot icon 302_4. As such, tapping the port selection field 573 may bring up a list of the same ports that are included in list 572. The user may then select a particular one of the ports by tapping that port in the list (not shown) provided via port selection field 573. When the user selects one of the ports, other features in the control panel 301 may then be used to control and/or view information related to the selected port. Screen 570 indicates that the first port in list 572 is currently selected (e.g., as indicated by the darker color of port 1 in list 572, as compared to ports 2 to 4).

Since the downlink button 328 is selected on screen 570, the GUI may display one or more combiner features corresponding to combiner slot represented by the selected POI slot icon 302_4. In particular, screen 570 includes: (a) a slot number indication 574 (which indicates how many slots are combined in the combiner slot), (b) an output power indication 576, and (c) a temperature indication 578. The output power indication 576 indicates the power level at the output of the downlink path of the corresponding combiner module of the DAS-I system.

The temperature indication 578 may indicate a temperature reading corresponding to the downlink processor for the slot of DAS-I system that corresponds to the selected POI slot icon. For example, screen 570 indicates that the temperature reading at the downlink processor for the combiner slot is 29.68° C. Other examples are also possible.

In a further aspect of such a combiner downlink mode, the control panel 301 may include one or more downlink selector features, corresponding to various aspects of the downlink of the port that is selected in the port selection field 573 (and highlighted in list 572). For instance, on screen 570, the control panel 301 includes (a) a minimum input power feature 580, and (b) a maximum input power feature 582. The minimum and maximum input power features 580 and 582 may allow the user to specify and adjust the minimum and maximum power levels to be applied to the downlink path of the currently associated combiner module, by the downlink power management feature(s) of the DAS-I system.

In the illustrated example, screen 570 may allow a user to adjust various downlink parameters for the selected port via touch interaction with the downlink selector features. For instance, in screen 570, the control panel 301 includes a touch-operable slider feature 590. Further, in screen 570, minimum input power feature 580 and maximum input power feature 582 each take the form of a touch-operable button graphic. As such, the user may tap the button graphic for the particular the downlink parameter that the user would like to adjust. The slider feature 590 can then be used to adjust the downlink parameter corresponding to the selected control feature, for the currently selected port from the combiner slot.

E. Illustrative Touch-Based GUI—Other Features

Referring back to FIG. 3, an example GUI may provide various other touch-based features. For example, screen 300 includes a device icon 311, an alarm icon 313, and a settings icon 315. Note that in the illustrated embodiment, the features provided by these icons may be continuously available. However, this is not required.

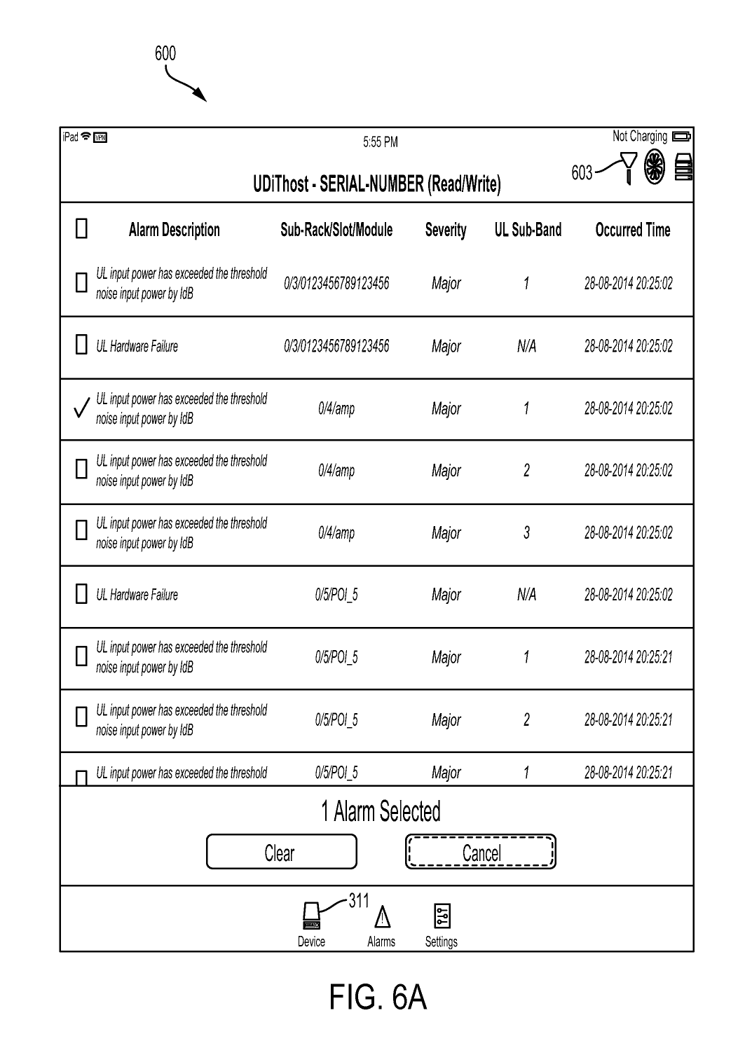

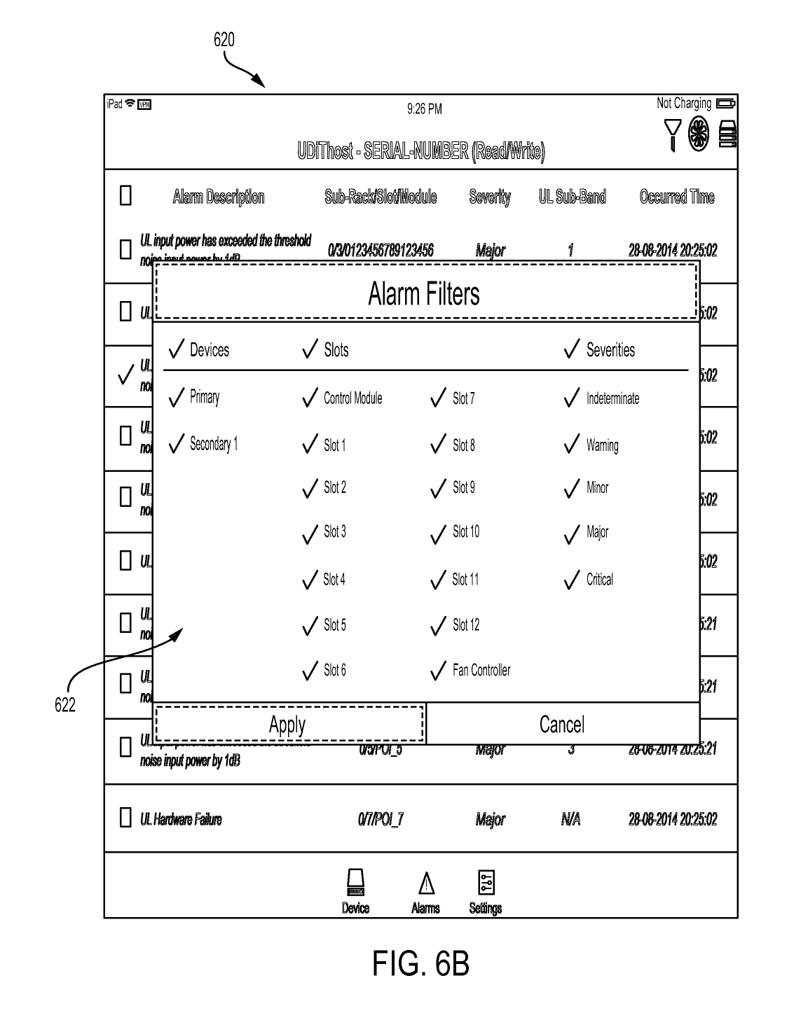

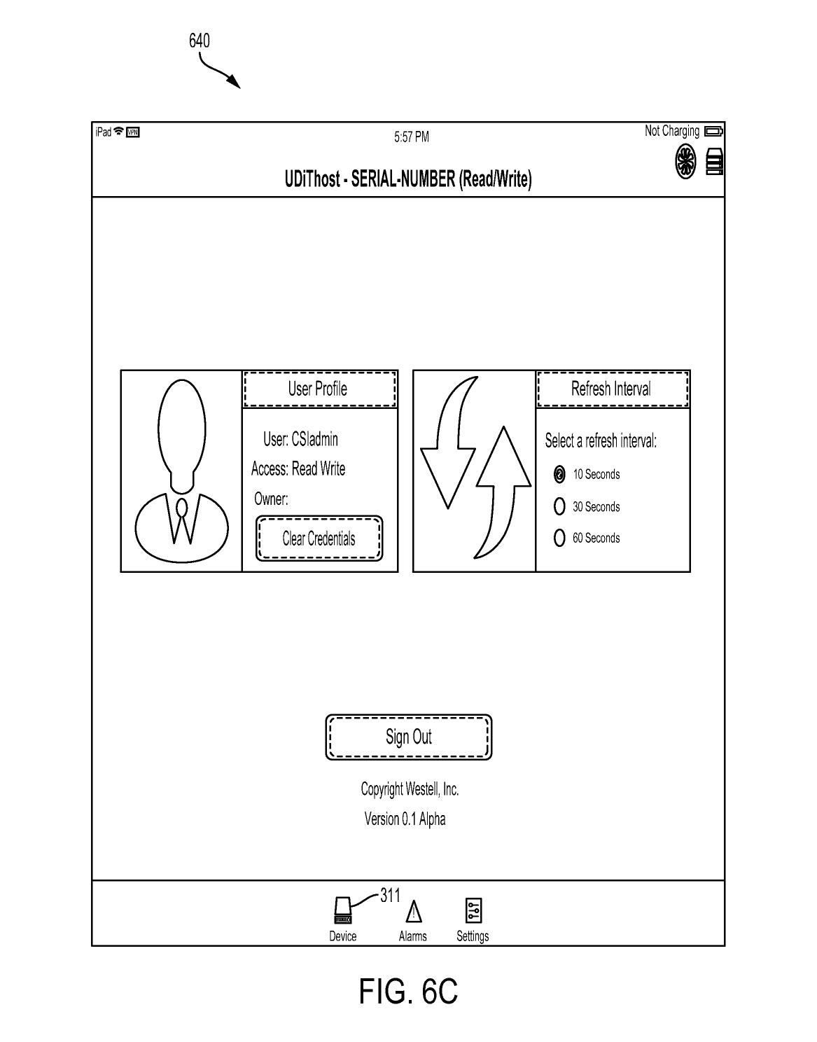

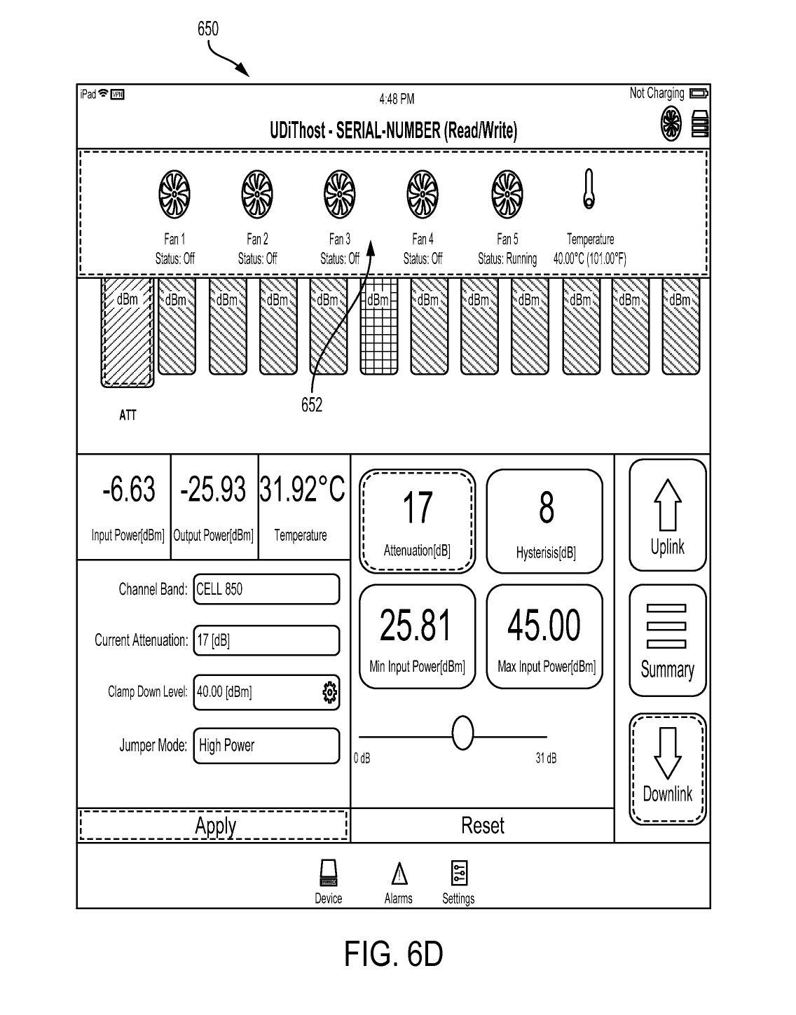

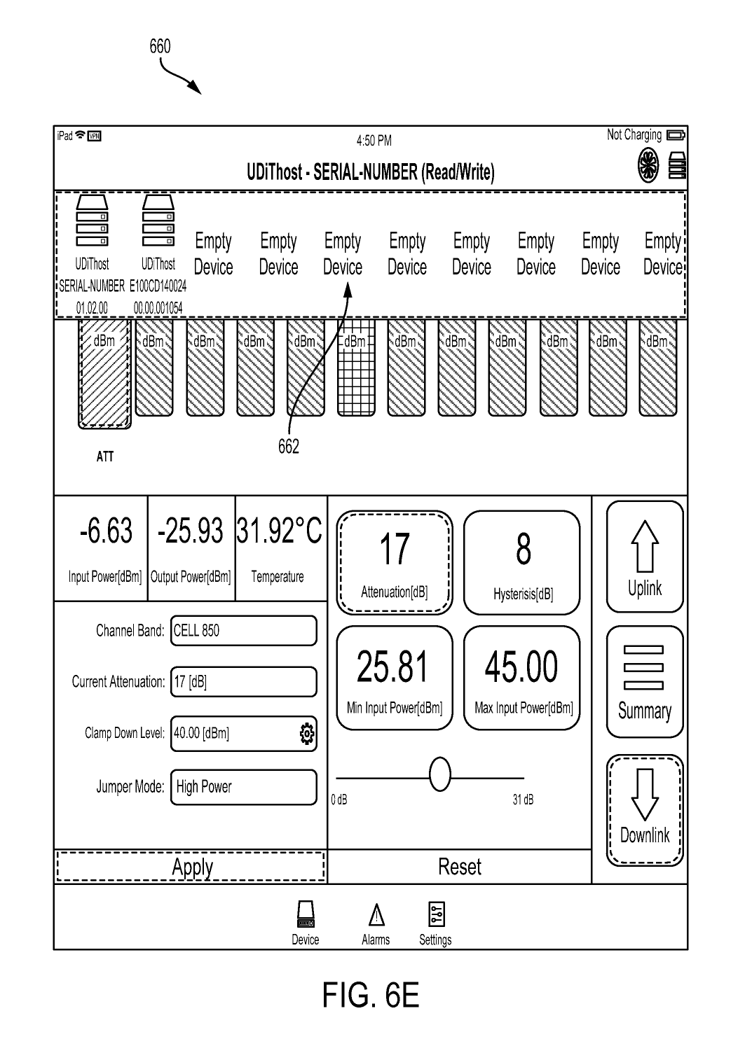

A user may tap the alarm icon 313 to access an alarm screen. An example of an alarm screen is shown in FIG. 6. More specifically, FIG. 6A shows a screen 600 where all the alarms associated with a DAS-I system are listed. Screen 600 may provide touch-based controls for selecting and clearing alarms from the list of alarms.

In a further aspect, an example GUI may include touch-based features that allow the user to adjust alarm filters that are applied by a DAS-I system at a remote location. For example, a user may access an alarm filter settings screen via alarm screen 600, such as by tapping filter icon 603. FIG. 6B shows an example in which a user has opened an alarm filter settings window 622. In particular, FIG. 6B shows a screen 420, where an alarm filter settings window 622 is displayed over alarm filter settings window 622 the alarms screen shown in FIG. 6A. The user may turn alarm filter parameters on and off by tapping on each alarm filter parameter shown in alarm filter settings window 622.

A user may tap the settings icon 314 to access a settings screen. An example of a settings screen is shown in FIG. 6C. More specifically, FIG. 6C shows a screen 640 where settings of the application can be adjusted via a touchscreen interface. In the illustrated example, screen 640 includes the credentials associated with the user account that is currently logged in to the application (e.g., user name, access level, etc.). Screen 640 also includes a feature for the setting refresh interval, which allows the user to adjust how often the DAS-I system takes power measurements and provides updated information to the touchscreen device.

In another aspect, the screens shown in FIGS. 3A to 5D may be considered the device view of the GUI (with the different screens shown in those figures representing different modes or states within the primary view). When the user accesses a screen such as the alarms screen 600 or settings screen 640, the user has navigated away from the device view within the application. When a user has navigated away the device view, the user may simply tap on the device icon 311 to return to the device view.

Referring again to FIG. 3A, in another aspect, a user may tap a fan icon 321 to access a fan settings feature. An example of a fan settings feature is shown in FIG. 6D. More specifically, FIG. 6D shows a screen 650 with a fan settings drop-down 652, displayed over the screen shown in FIG. 5A. The fan settings drop-down 652 includes a fan control icon for each fan of the associated DAS-I system, as well as a temperature indication for the DAS-I, which may be helpful to the user in evaluating whether to turn fans on or off. The user may tap a fan control icon in fan settings drop-down 652 to turn the corresponding fan of the DAS-I on and off.

In yet another aspect, a user may tap a DAS-I icon 323 to access a DAS-I selection feature. An example of a DAS-I selection feature is shown in FIG. 6E. More specifically, FIG. 6E shows a screen 660 with a DAS-I selection drop-down feature 662. The DAS-I selection drop-down feature 662 may include a DAS-I icon for each DAS-I system that is currently accessible via the application. As such, DAS-I selection drop-down feature 662 may allow the user may tap the various DAS-I icons that are not empty, in order to switch between viewing information and/or controlling different DAS-I systems.

F. Illustrative Touch-Based GUI for Smaller Screens

As noted above, FIGS. 7A to 7I show screens from an example application, which may be implemented on a smaller touch-based interface, such as on the touchscreen of a mobile phone. Note that while a login screen is not shown, a user may be required to login to the GUI shown in FIGS. 7A to 7I via a login screen with similar features as those described in reference to FIG. 2 above.

FIG. 7A shows a screen 700 with a grid of POI slot icons, with each POI slot icon corresponding to at least one of a plurality of POI modules of a DAS-I system that is currently associated with the application. For example, screen 700 includes POI slot icons 702_1 to 702_12. Further, the GUI may include a name label for each POI slot 702_1 to 702_12. For instance, in the illustrated example, POI slot 702_2 is labeled with the name “Cricket POI_1,” POI slot 702_3 is labeled with the name “A Very Long Name POI_2” (which may be a default naming convention), and so on.

An example GUI may additionally or alternatively include an input-power label for one or more of POI slot icons 702_1 to 702_12. The input power label for a given POI slot icon 702_1 to 702_12 may indicate the input power at the POI module that corresponds to the given POI slot icon. For instance, in the illustrated example, POI slot 702_2 includes an input power label that reads “−10 dBm,” POI slot 702_3 includes an input power label that reads “−7 dBm,” and so on.

Note that in some implementations, such as the implementation shown in FIG. 7A, a user may be able to control some, but not all, of the POI modules from a given DAS-I system. Accordingly, when the user that is logged in to the application does not have access to particular POI module, they may be prevented from selecting the POI slot icon corresponding that particular POI module. Further, such a POI slot icon, which is not selectable by the particular user that is logged in to the application may include a visual indication to this effect. For example, on screen 700 POI slot icons 702_1, 702_8, 702_11, and 702_12 may read “Access Denied,” thus indicating that the user that is currently logged in does not have access rights to the corresponding POI modules of the current DAS-I system.

In a further aspect, the application may be configured to receive touch-based input data that indicates the selection of a particular one of the POI slot icons 702_1 to 702_12. For instance, to select a given one of POI slot icons 702_1 to 702_12, a user may tap the touchscreen at a location where the given POI slot icon is displayed. In response to the touch input data indicating the selection of a particular POI slot icon from the plurality of POI slot icons, the GUI may display a control view for the selected POI slot icon.

For example, FIG. 7B shows a screen 720 that provides a control view for a selected POI slot, according to an example embodiment. More specifically, screen 720 may be displayed in response to the user tapping on POI slot icon 702_2 in screen 700. In the illustrated embodiment, the control view may include one or more mode buttons that allow a user to switch between two or more modes of the control panel using touch input. For instance, the two or more modes may include two or more of an uplink mode, a summary mode, and a downlink mode. In the example shown in FIGS. 7B to 7E, the control view includes an uplink mode button 724, a summary mode button 722, and a downlink mode button 726.

Accordingly, screen 720 may be displayed when a user taps summary button 722. Screen 720 may provide information, features, and fields that are the same as or similar to those described in reference to the summary mode of control panel 301 as shown in FIG. 3. In other words, rather than switching a control panel between different modes, while all the time displaying the POI slot icons, the GUI that is illustrated in FIGS. 7A to 7I switches between the screen that displays the POI slot icons and screens for controlling aspects of the selected POI slot, which may be advantageous on a smaller screen.

In response to touch input data indicating to provide an uplink mode, the application may display an uplink screen for the POI module corresponding to the currently selected POI slot icon. For instance, FIGS. 7C and 7D illustrate examples of screens 730 and 740 that may be displayed in the control view when a user taps the uplink button 724. Screen 730 may provide information, features, and fields that are the same as or similar to those described in reference to the uplink mode of control panel 301 as shown in FIGS. 4C and 4D. (Note that the “Graph” button shown in FIG. 7C may function in the same or similar manner as the “Scan” button shown in FIG. 4C.) Similarly, screen 740 may provide information, features, and fields that are the same as or similar to those described in reference to the uplink mode of control panel 301 as shown in FIGS. 4A and 4B.

In response to touch input data indicating to provide a downlink mode, the application may display a downlink screen for the POI module corresponding to the currently selected POI slot icon. For instance, FIG. 7E illustrates an example screen 750 that may be displayed in the control view when a user taps the downlink button 726. Screen 750 may provide information, features, and fields that are the same as or similar to those described in reference to the downlink mode of control panel 301 as shown in FIGS. 5A to 5C.

Referring back to FIG. 7A, screen 700 also device icon 711, an alarm icon 713, and a settings icon 715. A user may tap on alarm icon 713 to view an alarm screen. An example of an alarm screen is shown in FIG. 7F. More specifically, FIG. 7F shows a screen 760 where all the alarms associated with the currently selected DAS-I system are listed. Screen 760 may provide touch-based controls for selecting and clearing alarms from the list of alarms.

A user may tap the settings icon 715 to access a settings screen. An example of a settings screen is shown in FIG. 7G. More specifically, FIG. 7G shows a screen 770 where settings of the application can be adjusted via a touchscreen interface. In the illustrated example, screen 770 includes the credentials associated with the user account that is currently logged in to the application (e.g., user name, access level, etc.). Screen 770 also includes a feature for the setting refresh interval, which allows the user to adjust how often the DAS-I system takes power measurements and provides updated information to the touchscreen device.

In another aspect, a user may tap a fan icon 723 to access a fan settings feature. An example of a fan settings feature is shown in FIG. 7H. More specifically, FIG. 7H shows a screen 780 with a fan settings slide-in menu 782 displayed over the screen shown in FIG. 7A. The fan settings slide-in menu 782 includes a fan control icon for each fan of the associated DAS-I system, as well as a temperature indication for the DAS-I, which may be helpful to the user in evaluating whether to turn fans on or off. The user may tap a fan control icon in fan settings slide-in menu 782 to turn the corresponding fan of the DAS-I on and off.

In yet another aspect, a user may tap a DAS-I icon 721 to access a DAS-I selection feature. An example of a DAS-I selection feature is shown in FIG. 7I. More specifically, FIG. 7I shows a screen 790 with a DAS-I selection slide-in menu 792. The DAS-I selection slide-in menu 792 may include a DAS-I icon for each DAS-I system that is currently accessible via the application. As such, DAS-I selection slide-in menu 792 may allow the user may tap the various DAS-I icons that are not empty, in order to switch between viewing information and/or controlling different DAS-I systems via the application.

G. Implementation of Illustrative GUIs on Non-Touch-Based Devices

In alternative embodiments, an application for controlling a DAS-I system may be executed on a computing device that does not include a touchscreen, such as a laptop or desktop computer. In such embodiments, the GUI may have the same or similar layouts as the GUIs described herein as being displayed on touchscreens. However, the input mechanism for interacting with the GUI may be adapted for a non-touchscreen device. For example, the application may allow a mouse to be used to interact with the GUI (e.g., by clicking when a mouse pointer is at a desired location instead of tapping a touchscreen at that location, by moving a mouse while holding a mouse button down instead of swiping on a touchscreen, etc.). Other examples of non-touch-based input are also possible.

### III. ILLUSTRATIVE METHODS

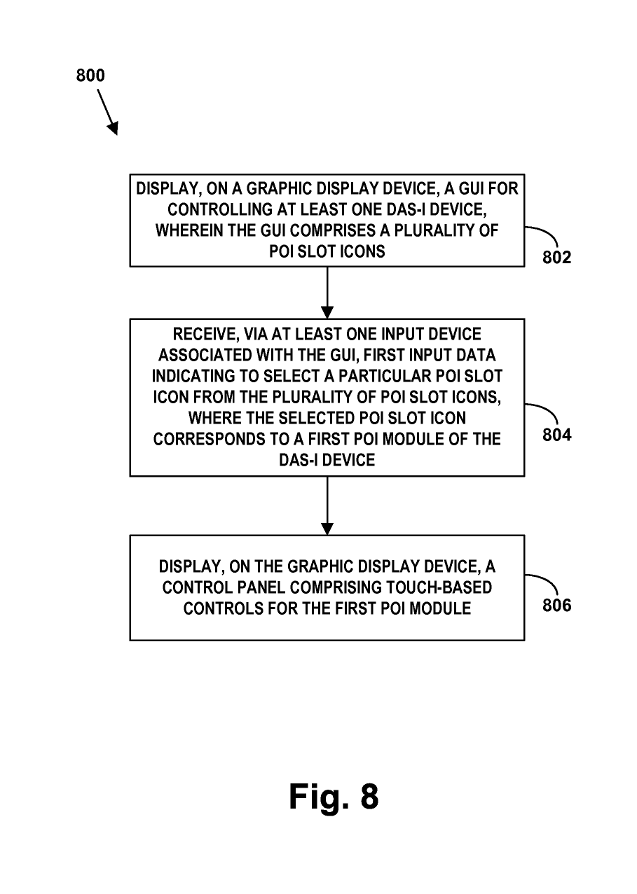

FIG. 8 is a flow chart illustrating a method 800 according to an example embodiment. Method 800 may be implemented on or in association with various types of computing devices, in order to control a DAS-I system.

More specifically, as shown by block 802, method 800 involves displaying, on a graphic display device, a GUI for controlling at least one DAS-I device. The GUI includes a plurality of POI slot icons, with each POI slot icon corresponding to at least one of a plurality of POI modules of the DAS-interface device. For example, the GUI shown in FIG. 7A may be displayed at block 802. Other examples are also possible. Further, the graphic display device may be a touchscreen, such as that which is typically provided on a mobile phone or tablet computer. Alternatively, the graphic display device may be an integrated display of a laptop computer, or a display device connected to a personal computer, among other possibilities.

At block 804, the method further involves receiving, via at least one input device associated with the GUI, first input data indicating to select a particular POI slot icon from the plurality of POI slot icons. In some embodiments, the at least one input device may be a touchscreen (e.g., a graphic display combined with an array of capacitive touch sensors), or a touchpad. In other embodiments, the at least one input device could be a mouse or another pointing device. Other types of input devices may also be utilized to interact with the GUI.

Further, in an example embodiment, the selected POI slot icon may correspond to a POI module that is connected to a BTS from a cellular network. However, it should be understood that POI modules connected to other types of network components could also be controlled via an exemplary method, without departing from the scope of the invention.

Next, at block 806, the method involves displaying, on the graphic display device, a control panel comprising touch-based controls for a first POI module corresponding to the selected POI slot icon, where the first POI module connects to at least one network component of a radio access network. In other words, the GUI may be updated to provide graphic control features for a POI module that is selected via a user interaction with the POI slot icon for the particular POI module.

In a further aspect, once graphic control features for the first POI module are displayed at block 806, a user may further interact with these control features in order to control the functioning of the POI module. In this regard, an exemplary method may further involve receiving, via the at least one input device associated with the GUI, second input data corresponding to interaction with one or more graphic control features for the first POI module (not shown in FIG. 8). In response to such second input data, the computing device performing the method may send, to the DAS-I device, at least one instruction for control of the first POI module. The instruction corresponds to the interaction with one or more graphic control features for the first POI module. For example, the instruction may correspond to interaction with various POI module control features shown in FIGS. 2 to 5D.

It should be understood that an exemplary method may further involve providing other screens of a GUI for controlling a DAS-I interface, such as the screens shown in FIGS. 2 to 7I. Further, an exemplary method may involve receiving input data corresponding to interactions with features of GUI screens such as those shown in FIGS. 2 to 7I. Other variations on the methods described herein are also possible.

### IV. ILLUSTRATIVE COMPUTING DEVICES

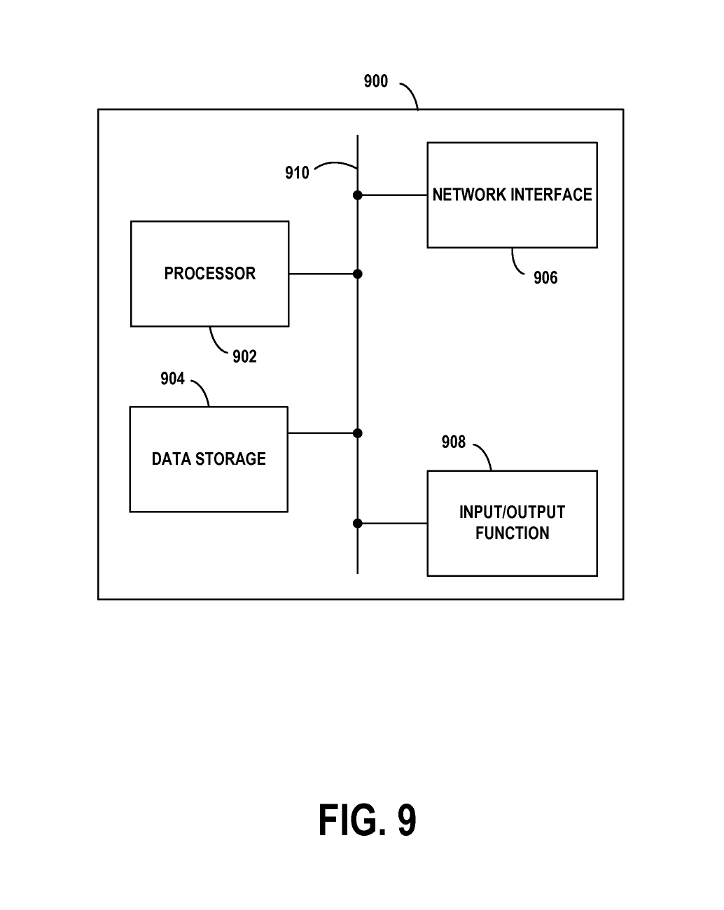

FIG. 9 is a block diagram illustrating a computing device 900. In particular, FIG. 9 shows exemplary functional components that could be included in a computing device arranged to operate in accordance with the embodiments herein. Example computing device 900 could be any type of client device that is configured to allow for control of a DAS-I device. Note that a DAS-I device may also be a computing device, and as such, may have similar components as those described in reference to computing device 900. More generally, the description of computing device 900 could apply to any computing device or component used for the purposes described herein.

As shown, computing device 900 includes a processor 902, a data storage 904, a network interface 906, and an input/output function 908, all of which may be coupled by a system bus 910 or a similar mechanism. In some embodiments, processor 902 can include one or more CPUs, such as one or more general purpose processors and/or one or more dedicated processors (e.g., application specific integrated circuits (ASICs), digital signal processors (DSPs), network processors, etc.). Processor 902 may take other forms as well.

Data storage 904 may take the form of volatile and/or non-volatile data storage, which may be integrated in whole or in part with processor 902, or may be implemented separately from processor 902. Data storage 904 can include program instructions stored thereon, which are executable by a processor such as processor 902. Data storage 904 can also include data that may be manipulated by such program instructions to carry out the various methods, processes, or operations described herein. Alternatively, the methods, processes, or operations can be carried out by hardware, firmware, and/or any combination of hardware, firmware and software. By way of example, the data in data storage 904 may contain program instructions, perhaps stored on a non-transitory, computer-readable medium, and executable by processor 902, to carry out any of the methods, processes, or operations disclosed in this specification or the accompanying drawings.

Network interface 906 may take the form of a wireline interface, such as hardware, firmware, and/or software that provides the computing device 900 with an Ethernet, Token Ring, and/or T-carrier connection. Network interface 906 may additionally or alternatively take the form of a wireless interface, such as hardware, firmware, and/or software that provides the computing device 900 with an IEEE 802.11 (Wifi), BLUETOOTH®, or a wide-area wireless connection, among other possibilities. However, other forms of physical layer connections and other types of standard or proprietary communication protocols may be used over network interface 906. Furthermore, network interface 906 may comprise multiple physical interfaces. Further, network interface 906 may allow a computing device 900 to communicate with and/or to control a DAS-I device.

Input/output function 908 may facilitate user interaction with example computing device 900. Input/output function 908 may comprise multiple types of input devices, such as a keyboard, a mouse, a touchscreen, and so on. Similarly, input/output function 908 may comprise multiple types of output devices, such as a screen, monitor, printer, or one or more light emitting diodes (LEDs). Additionally or alternatively, computing device 900 may support remote access from another device, via network interface 906 or via another interface (not shown), such as a universal serial bus (USB) or high-definition multimedia interface (HDMI) port.

### V. CONCLUSION

The particular arrangements shown in the Figures and described in this specification should not be viewed as limiting. For instance, it should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

I claim:

1. An apparatus for control of a distributed antenna system, the apparatus comprising:
a touchscreen;
a non-transitory computer readable medium; and
program instructions stored on the non-transitory computer readable medium and executable by at least one processor to:
display, on the touchscreen, a touch-based graphical user-interface (GUI) for controlling at least one distributed antenna system (DAS) interface device, wherein the GUI comprises a plurality of point-of-interface (POI) slot icons, wherein each POI slot icon corresponds to at least one of a plurality of POI modules of the DAS-interface device;
receive, via the touchscreen, touch input data indicating to select a particular POI slot icon from the plurality of POI slot icons; and
display, on the touchscreen, a control panel comprising touch-based controls for the POI module corresponding to the selected POI slot icon.

2. The apparatus of claim 1, wherein the touch-based GUI further comprises a name label for each POI slot.

3. The apparatus of claim 1, wherein the touch-based GUI further comprises an input power label for each POI slot.

4. The apparatus of claim 1, further comprising program instructions stored on the non-transitory computer readable medium and executable by at least one processor to:
determine an alarm status for each of one or more of the POI slots; and
color code each of the one or more of the POI slots based on the respective alarm status of the POI slot.

5. The apparatus of claim 1, further comprising program instructions stored on the non-transitory computer readable medium and executable by at least one processor to, in response to the touch input data indicating to select a particular POI slot from the plurality of POI slots, visually identify the selected POI slot in the touch-based GUI.

6. The apparatus of claim 1, wherein the control panel comprises one or more mode buttons for switching between two or more modes of the control panel, wherein the two or more modes comprise two or more of an uplink mode, a summary mode, and a downlink mode.

7. The apparatus of claim 6, wherein the one or more mode buttons comprise an uplink mode button, a summary mode button, and a downlink mode button.

8. The apparatus of claim 1, further comprising program instructions stored on the non-transitory computer readable medium and executable by at least one processor to, in response to the touch input data indicating to provide a summary mode in the control panel, cause the control panel to display a summary of the at least one port corresponding to a selected POI slot.

9. The apparatus of claim 8, wherein providing the summary mode in the control panel comprises display of one or more features corresponding to the selected POI slot, wherein the one or more features comprise one or more of: (a) an alarm panel, (b) an input power indication, (c) a channel band indication, and (d) a status indication.

10. The apparatus of claim 8, wherein providing the summary mode in the control panel comprises display of one or more fields corresponding to the selected POI slot, wherein the one or more fields comprise one or more of: (a) an ID field, (b) a name field, (c) a type field, and (d) a description field.

11. The apparatus of claim 1, further comprising program instructions stored on the non-transitory computer readable medium and executable by at least one processor to, in response to the touch input data indicating to provide an uplink mode in the control panel, cause the control panel to display uplink features for the at least one port corresponding to a currently selected POI slot.

12. The apparatus of claim 11, wherein providing the uplink mode in the control panel comprises display of one or more uplink features corresponding to the selected POI slot, wherein the one or more features comprise one or more of: (a) a channel band indication, (b) a temperature indication and (c) a status indication.

13. The apparatus of claim 11, wherein providing the summary mode in the control panel comprises display of one or more touch-operable uplink control features corresponding to the selected POI slot, wherein the one or more touch-operable uplink control features comprise one or more of: (a) an input power control feature, (b) a hysteresis control feature, and (c) an attenuation control feature.

14. The apparatus of claim 11, wherein providing the uplink mode in the control panel comprises display of an output power information panel corresponding to the selected POI slot.

15. The apparatus of claim 14, wherein the port corresponding to the selected POI slot is communicatively coupled to a base station serving a plurality of sectors, wherein the output power information panel comprises, for each of the plurality of sectors, an output power indication for each of plurality of channel bands.

16. The apparatus of claim 14, wherein the output power information panel at least one control feature for adjusting parameters of the output power information panel.

17. The apparatus of claim 11 wherein providing the uplink mode in the control panel comprises providing spectrum analyzer panel, wherein the spectrum analyzer panel comprise a graph of input power as a function of frequency for the selected POI slot.

18. The apparatus of claim 17, wherein the spectrum analyzer panel comprises at least one control feature for adjusting parameters of the graph.

19. The apparatus of claim 1, further comprising program instructions stored on the non-transitory computer readable medium and executable by at least one processor to, in response to the touch input data indicating to provide a downlink mode in the control panel, cause the control panel to display downlink features for the at least one port corresponding to a currently selected POI slot.

20. The apparatus of claim 19, wherein providing the downlink mode in the control panel comprises display of one or more downlink features corresponding to the selected POI slot, wherein the one or more features comprise one or more of: (a) an input power indication, (b) a temperature indication and (c) an output power indication.

21. The apparatus of claim 1, wherein providing the downlink mode in the control panel comprises display of one or more downlink control features corresponding to the selected POI slot, wherein the one or more downlink control features comprise one or more of: (a) a channel band field, (b) a current attenuation field, (c) a clamp down level field, and (d) a jumper mode field.

22. The apparatus of claim 1, wherein at least one POI slot is assignable to combination of two or more of the ports.

23. The apparatus of claim 22, further comprising program instructions stored on the non-transitory computer readable medium and executable by at least one processor to, in response to the touch input data selecting a POI slot that is assigned to a combination of two or more ports, updating the control panel to display touch-based combiner features corresponding to the selected POI slot.

24. The apparatus of claim 23, wherein the control panel comprises individual port information for each of the two or more ports, and one or more touch-based features for selection of a particular one of the two more ports.

25. An apparatus for control of a distributed antenna system, the apparatus comprising:
an interface to a graphic display device;
an interface to at least one input device;
a non-transitory computer readable medium; and
program instructions stored on the non-transitory computer readable medium and executable by at least one processor to:
display, on the graphic display device, a graphical user-interface (GUI) for controlling at least one distributed antenna system (DAS) interface device, wherein the GUI comprises a plurality of point-of-interface (POI) slot icons, wherein each POI slot icon corresponds to at least one of a plurality of POI modules of the DAS-interface device;
receive, via the at least one input device, first input data indicating to select a particular POI slot icon from the plurality of POI slot icons; and
display, on the graphic display device, a control panel comprising touch-based controls for the POI module corresponding to the selected POI slot icon.

26. A method comprising:
displaying, on a graphic display device, a graphical user-interface (GUI) for controlling at least one distributed antenna system (DAS) interface device, wherein the GUI comprises a plurality of point-of-interface (POI) slot icons, wherein each POI slot icon corresponds to at least one of a plurality of POI modules of the DAS-interface device;
receiving, via at least one input device associated with the GUI, first input data indicating to select a particular POI slot icon from the plurality of POI slot icons; and
displaying, on the graphic display device, a control panel comprising touch-based controls for a first POI module corresponding to the selected POI slot icon, wherein the first POI module connects to at least one network component of a radio access network.

27. The method of claim 27, wherein graphic display device comprises a touchscreen, and wherein the first input data comprises touch input data.

28. The method of claim 27, further comprising:
receiving, via the at least one input device associated with the GUI, second input data corresponding to interaction with one or more graphic control features for the first POI module; and
sending, to the DAS interface system, at least one instruction for control of the first POI module, wherein the at least one instruction corresponds to the interaction with one or more graphic control features for the first POI module, and wherein implementation of the at least instruction changes the operation of the POI module with respect to at least one of uplink or downlink traffic of the at least one network component connected to the first POI module.

29. The method of claim 27, wherein the at least one network component comprises a base transceiver station (BTS).
